(19) United States
(12) Patent Application Publication
(10) Pub. No.: US 2011/0313956 A1
(43) Pub. Date: Dec. 22, 2011

(54) INFORMATION PROCESSING APPARATUS, INFORMATION PROCESSING METHOD AND PROGRAM

(75) Inventors: Shinichiro Abe, Tokyo (JP); Takashi Usui, Tokyo (JP); Masayuki Takada, Tokyo (JP)

(73) Assignee: Sony Corporation, Tokyo (JP)

(21) Appl. No.: 13/155,637

(22) Filed: Jun. 8, 2011

(30) Foreign Application Priority Data
Jun. 16, 2010 (JP) 2010-137555

(51) Int. Cl. G06F 15/18

(52) U.S. Cl. 706/12

(57) ABSTRACT

There is provided an apparatus including an information processing apparatus, including a behavior learning unit that learns an activity model representing an activity state of a user as a probabilistic state transition model from time-series data of the user's location, and that finds a state node corresponding to a location where the user conducts activities using the user's activity model, a candidate assigning unit that assigns category candidates related to location or time to the state node, and a display unit that presents the category candidate to the user.

### BACKGROUND

The present disclosure relates to an information processing apparatus, an information processing method, and a program.

An information providing service is service for providing user-specific information linked to location information or time zone to a client terminal that a user has. For example, an existing information providing service provides railroad traffic information, road traffic information, typhoon information, earthquake information, event information, or the like, according to areas and time zones the user has set in advance. Further, there is service for notifying a user of information which the user has registered in association with some area as a reminder when the user gets close to the registered area.

### SUMMARY

In the existing information providing service, the user is expected to register areas and time zones in advance in order to receive user-specific information linked with location information and time zone. For example, in order to receive service, such as the railroad traffic information, the road traffic information, the typhoon information, the earthquake information, the event information, or the like, linked with the area that the user uses, the user has to register own home or areas the user frequently visits by inputting from a client terminal, or the like. Further, if the user wants to register information in association with some areas and to receive reminders, the user has to operate for each of the areas to be registered, which is not convenient.

Further, if the user wants to set time for receiving information, the user has to register by inputting the time zone for receiving information from the client terminal, or the like. For this reason, there is an issue that the user is forced to input detail settings in order to receive user-specific information linked with location information and time zone. Especially, in order to receive information in a plurality of areas in a plurality of time zones, the user is forced to perform a lot of operations, increasing burden on the user.

JP 2009-159336A discloses a technology to predict topology of the user's travel route using the hidden Markov model (HMM) in order to monitor the user's activity. It is described that when a current location predicted in a step of location prediction indicates the same state label for a certain period of time and time frame at midnight, this technology recognizes the state label as a home, or the like, subject to be monitored for an activity range.

However, the above disclosure does not describe the state label is to be presented to the user, and to confirm the user. Adding all the state labels automatically without confirming the user includes uncertainty, so it becomes difficult to ensure certainty in providing information regarding information unallowable not to be provided, such as railway traffic information, or the like.

JP 4284351B discloses a technology that automatically selects notification modality (output form) for notifying that information has been received, based on an operation history of a mobile information terminal, eliminating operations for presetting the notification modality. In addition, it describes that in some cases it confirms the user regarding the setting of the notification modality.

However, JP 4284351B aims to confirm in order to decide the notification modality. For that reason, its technical field is different from the one of the user-specific information providing service linked to location information and time zones, in which the areas and the time zones have to be registered.

In light of foregoing, it is desirable to provide an information processing apparatus, an information processing method and a program, which are novel and improved, and which are capable of finding a state node corresponding to a location where a user conducts activities using the user's activity model, and of setting categories easily to the state node when recognizing the user's activities.

According to an embodiment of the present disclosure, there is provided an information processing apparatus, including a behavior learning unit that learns an activity model representing an activity state of a user as a probabilistic state transition model from time-series data of the user's location, and that finds a state node corresponding to a location where the user conducts activities using the user's activity model, a candidate assigning unit that assigns category candidates related to location or time to the state node, and a display unit that presents the category candidate to the user.

The information processing apparatus may further include a map database including map data and attribute information of a location associated with the map data, and a category extraction unit that extracts the category candidates based on the state node and the map database.

The information processing apparatus may further include a behavior prediction unit that predicts routes available from the state node, a labeling unit that registers at least one of the category candidates among the category candidates as a label to the state node, and an information presenting unit that provides information related to the state node included in the predicted routes based on the registered label.

The information related to the state node may be determined in accordance with an attribute of the label.

According to another embodiment of the present disclosure, there is provided an information processing method which includes'learning an activity model representing an activity state of a user as a probabilistic state transition model from time-series data of the user's location, and finding a state node corresponding to a location where the user takes actions using the user's activity model, assigning category candidates related to location or time to the state node, and presenting the category candidate to the user.

According to another embodiment of the present disclosure, there is provided a program for causing a computer to execute learning an activity model representing an activity state of a user as a probabilistic state transition model from time-series data of the user's location, and that finds a state node corresponding to a location where the user takes actions using the user's activity model, assigning category candidates related to location or time to the state node, and presenting the category candidate to the user.

According to the embodiments of the present disclosure described above, it is possible to find a state node corresponding to a location where a user conducts activities using the user's activity model, and to set categories easily to the state node when recognizing the user's activities.

### BRIEF DESCRIPTION OF THE DRAWINGS

FIG. 1 is a block diagram showing a configuration example of a prediction system according to an embodiment of the present disclosure;

FIG. 2 is a block diagram showing a hardware configuration example of the prediction system;

FIG. 3 is a diagram showing an example of time-series data to be input into the prediction system;

FIG. 4 is a diagram showing an example of HMM;

FIG. 5 is a diagram showing an example of HMM used for voice recognition;

FIG. 6 is a diagram showing an example of HMM given with a sparse restriction;

FIG. 7 is a diagram showing an example of processing for searching routes by a behavior prediction unit;

FIG. 8 is a flow chart showing user activity model learning processing;

FIG. 9 is a block diagram showing the first configuration example of the behavior learning unit in FIG. 1;

FIG. 10 is a block diagram showing the second configuration example of the behavior learning unit in FIG. 1;

FIG. 11 is a block diagram showing the first configuration example of a learning device corresponding to the behavior state recognition unit in FIG. 9;

FIG. 12 is showing a classification example of a behavior state;

FIG. 13 is a diagram explaining a processing example of a behavior state labeling unit in FIG. 11;

FIG. 14 is a diagram explaining a processing example of the behavior state labeling unit in FIG. 11;

FIG. 15 is a block diagram showing a configuration example of the behavior state learning unit in FIG. 11;

FIG. 16 is a diagram showing learning results by the behavior state learning unit in FIG. 11;

FIG. 17 is a block diagram showing a configuration example of a behavior state recognition unit corresponding to the behavior state learning unit in FIG. 11;

FIG. 18 is a block diagram showing the second configuration example of a learning device corresponding to the behavior state recognition unit in FIG. 9;

FIG. 19 is a diagram explaining a processing example of the behavior state labeling unit;

FIG. 20 is a diagram showing learning results by the behavior state learning unit in FIG. 20;

FIG. 21 is a block diagram showing a configuration example of a behavior state recognition unit corresponding to the behavior state learning unit in FIG. 20;

FIG. 22 is a flow chart showing destination arrival time prediction processing;

FIG. 23 is a flow chart showing destination arrival time prediction processing;

FIG. 24 is a diagram showing an example of processing results by the prediction system in FIG. 10;

FIG. 25 is a diagram showing an example of processing results by the prediction system in FIG. 10;

FIG. 26 is a diagram showing an example of processing results by the prediction system in FIG. 10;

FIG. 27 is a diagram showing an example of processing results by the prediction system in FIG. 10;

FIG. 28 is an explanatory diagram showing a flow of processing for creating a behavior pattern table;

FIG. 29 is an explanatory diagram showing a classification of behavior modes;

FIG. 30 is an explanatory diagram showing a behavior pattern table;

FIG. 31 is an explanatory diagram showing a flow of processing for route prediction;

FIG. 32 is an explanatory diagram showing a flow of assigning candidates from a behavior pattern table;

FIG. 33 is an explanatory diagram showing an example of presenting location registration to a user;

FIG. 34 is an explanatory diagram showing an example of a screen for location registration;

FIG. 35 is an explanatory diagram showing a modified behavior pattern table after deciding candidates;

FIG. 36 is an explanatory diagram showing the modified behavior pattern table which has been registered as a non-target destination;

FIG. 37 is an explanatory diagram showing a flow of prediction processing using the modified behavior pattern table;

FIG. 38 is an explanatory diagram showing a combination example of predicted destination and presented information;

FIG. 39 is an explanatory diagram showing an example of predicted route and presented information using the behavior pattern table;

FIG. 40 is an explanatory diagram showing an example of predicted route and presented information using the modified behavior pattern table;

FIG. 41 is a block diagram showing an information presenting system according to an embodiment of the present disclosure;

FIG. 42 is a flow chart showing a processing of an information presenting system according to an embodiment of the present disclosure; and

FIG. 43 is a block diagram showing a configuration example of an embodiment of a computer applied by the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The explanation will be given in the following order:

1. Prediction System

2. Information Presenting System

The information presenting system according to an embodiment of the present disclosure provides user-specific information linked with location information and time zones, to a client terminal that a user owns. The information presenting system according the present embodiment recognizes the user's habitual behavior using a learning model structured by a probability model using at least one of location, time, date, day of week, or weather, and presents candidates of areas and time zones to the user from the present system.

The information presenting system according to the present embodiment can facilitate the user to register areas and time zones by presenting candidates to the user, update the learning model, and increase accuracy of information presenting and reminders.

According to the present embodiment, it is possible to simplify necessary presetting in the information providing service for providing user-specific information linked with location information and time zone, and to minimize the user's inconvenience. In addition, it is possible to minimize the number of items to be presented by deciding contents that the present system presents to the user based on location of node and time zone in the learning model constructed in advance. Further, it becomes possible to provide information with less noise at an appropriate timing by combining with prediction using the learning model.

<1. Prediction System>

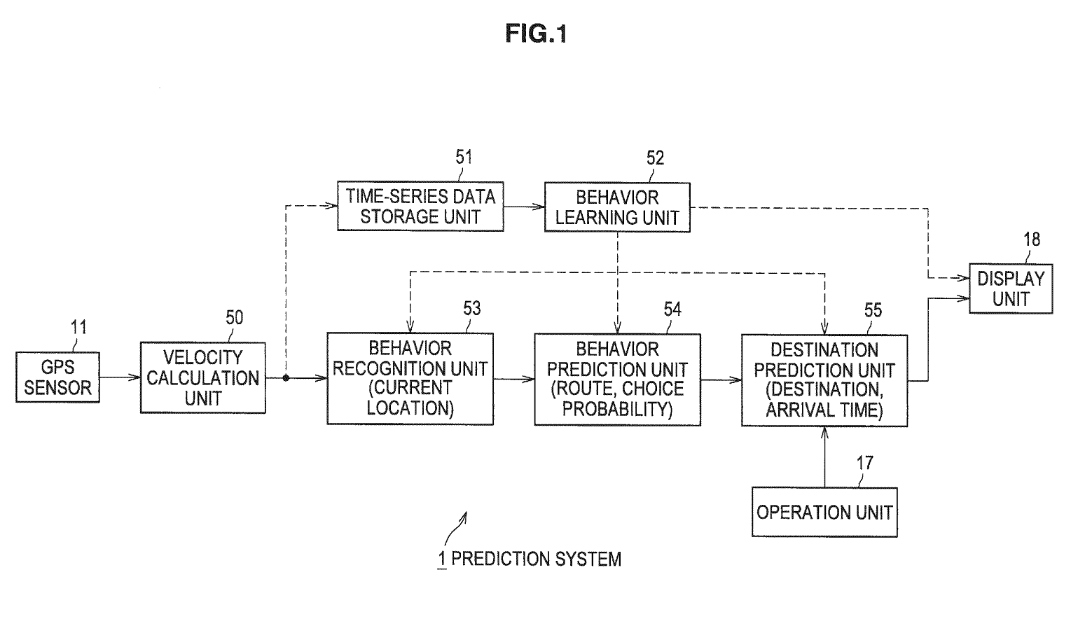

The information presenting system according to the present embodiment predicts future routes from a current location using a prediction system 1. FIG. 1 is a block diagram showing a configuration example of the prediction system according to the present embodiment.

The prediction system 1 in FIG. 1 includes a GPS sensor 11, a velocity calculation unit 50, a time-series data storage unit 51, a behavior learning unit 52, a behavior recognition unit 53, a behavior prediction unit 54, a destination prediction unit 55, an operation unit 17, and a display unit 18.

In the present embodiment, destination will be also predicted by the prediction system 1 based on time-series data of location obtained by the GPS sensor 11. The destination may not be one destination but in come cases a plurality of destinations may be predicted. The prediction system 1 calculates arrival probability, route, and arrival time regarding the predicted destination, and presents them to a user.

At locations to be destination, such as homes, offices, stations, shopping places, restaurants, or the like, the user generally stays there for a certain period of time, and moving velocity of the user is nearly 0. On the other hand, when the user is moving to a destination, the moving velocity of the user is in a state transitioning in a specific pattern depending upon means of transportation. Therefore, it is possible to recognize the user's behavior state, that is whether the user is in a state of staying at the destination (stay state) or in a state of moving (travel state), from information on the user's moving velocity, and to predict a place of the stay state as destination.

In FIG. 1, a dotted arrow indicates a flow of data in learning processing, and a solid arrow indicates a flow of data in prediction processing.

The GPS sensor 11 sequentially acquires data of latitude/longitude that indicates location thereof at a specific time interval (at every 15 seconds, for example). Note that there may be a case where the GPS sensor 11 is not able to acquire the location data at the specific time interval. For example, when staying in a tunnel or underground, it is not able to acquire satellite and the interval for acquiring may be longer. In this case, interpolation processing, or the like, can compensate data.

The GPS sensor 11 provides data of location (latitude/longitude) to be acquired to the time-series data storage unit 51 in the learning processing. In addition, the GPS sensor 11 provides location data to be acquired to the velocity calculation unit 50 in the prediction processing. Note that the present disclosure may be is measured its own location not only by a GPS, but by a base station or an access point of a wireless terminal.

The velocity calculation unit 50 calculates the moving velocity from the location data provided by the GPS sensor 11 at the specific time interval.

Specifically, if the location data acquired at k step (k-th step) in the specific time interval is expressed as time tₖ, longitude yₖ, latitude xₖ, moving velocity vxₖ in x direction and moving velocity vyₖ in y direction at k-th step can be calculated by the following expression (1).

$${vx}_{k} = \frac{{x}_{k} - {x}_{k - 1}}{{t}_{k} - {t}_{k - 1}} \\ {vy}_{k} = \frac{{y}_{k} - {y}_{k - 1}}{{t}_{k} - {t}_{k - 1}} \qquad ( 1 )$$

The expression (1) uses data of latitude/longitude acquired from the GPS sensor 11 as it is, however, it is possible to convert the latitude/longitude into distance, or to convert velocity so as to be expressed as per hour or minute, as necessary.

Further, the velocity calculation unit 50 can calculate moving velocity vₖ and traveling direction θₖ at k-th step expressed in the expression (2) from the moving velocity vxₖ and the moving velocity vyₖ acquired from the expression (1), and use them.

$${v}_{k} = \sqrt{{vx}_{k}^{2} + {vy}_{k}^{2}} \\ {θ}_{k} = {sin}^{- 1} ( \frac{{vx}_{k} \cdot {vy}_{k - 1} - {vx}_{k - 1} \cdot {vy}_{k}}{{v}_{k} - {v}_{k - 1}} ) \qquad ( 2 )$$

Features can be taken in a better way when using the moving velocity vₖ and traveling direction θₖ expressed by the expression (2) than when using the moving velocity vxₖ and the moving velocity vyₖ expressed by the expression (1) in the following points.

1. Since data distribution of the moving velocity vxₖ and the moving velocity vyₖ creates bias against a latitude/longitude axis, there is possibility not to be able to identify different angles of data whose means of transportation is the same (train, or walk). However, the moving velocity vₖ does not likely have such possibility.

2. Walk and STAY are hard to be distinguished if learning is executed only in an absolute size (|v|) because of some of |v| generated by a noise of devices. By taking a change of the traveling direction into consideration, influence of noise can be reduced.

3. Changes of the traveling direction are small when moving, however, since the traveling direction is difficult to be stable when staying, it is easier to identify moving and staying if the changes of the traveling direction are used.

According to the above reasons, in the form of the present embodiment, the velocity calculation unit 50 calculates the moving velocity vₖ and traveling direction θₖ expressed by the expression (2) as data of moving velocity, and provides it along with the location data to the time-series data storage unit 51 or the behavior recognition unit 53.

Further, the velocity calculation unit 50 executes filtering processing (preprocessing) by moving average to remove noise content before it calculates the moving velocity vₖ and traveling direction θₖ.

Note that the following description abbreviates a change of traveling direction θₖ as a traveling direction θₖ.

Some of the GPS sensor 11 may be able to output the moving velocity. In a case where such GPS sensor 11 is adapted, the velocity calculation unit 50 can be omitted, and the moving velocity output by the GPS sensor 11 can be utilized as it is.

The time-series data storage unit 51 stores location and time-series data of moving velocity provided by the velocity calculation unit 50. Since the time-series data storage unit 51 learns the user's behaviors and activity patterns, time-series data accumulated for a certain time of period is necessary.

The behavior learning unit 52 learns the user's travel route and behavior state as a probabilistic state transition model based on the time-series data stored in the time-series data storage unit 51. In other words, the behavior learning unit 52 recognizes the user's location, and learns the user's activity model, which is for predicting destination, its route and arrival time, as the probabilistic state transition model.

The behavior learning unit 52 provides parameters for the probabilistic state transition model obtained from the learning processing to the behavior recognition unit 53, the behavior prediction unit 54, and the destination prediction unit 55.

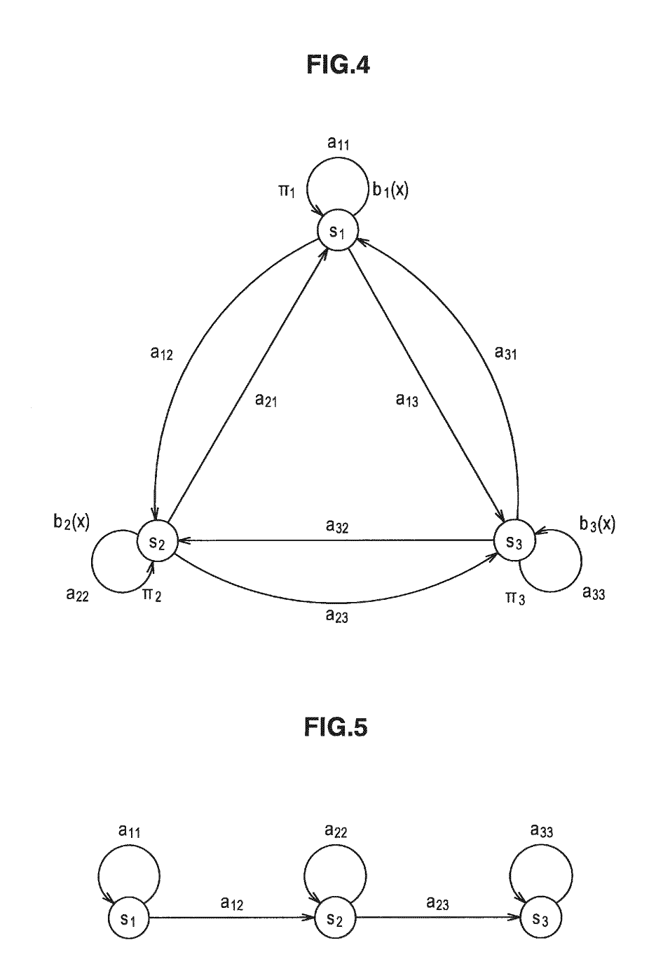

The behavior learning unit 52 learns the user's activity state carrying a device with the built-in GPS sensor 11 as the probabilistic state transition model based on the time-series data stored in the time-series data storage unit 51. Since the time-series data is data indicating the user's location, the user's activity state learned by the probabilistic state transition model is a state presenting time-series change of user's location, which is the user's travel route. As the probabilistic state transition model used for learning, for example, a probabilistic state transition model including a hidden state, such as the ergodic Hidden Markov Model, or the like. In the present embodiment, as the probabilistic state transition model, the ergodic Hidden Markov Model with a sparse restriction will be applied. Note that the ergodic Hidden Markov Model with sparse restriction, calculation method of the ergodic Hidden Markov Model, or the like will be explained later with reference with FIG. 4 to FIG. 6. Note that the learning model may be constructed by using not HMM, but RNN, FNN, SVR, or RNNPB.

The behavior learning unit 52 provides data indicating learning results to the display unit 18 to display it. Further, the behavior learning unit 52 provides parameters of the probabilistic state transition model obtained by the learning processing to the behavior recognition unit 53 and the behavior prediction unit 54.

The behavior recognition unit 53 uses the probabilistic state transition model of the parameters obtained through learning to recognize the user's current location from the time-series data of location and moving velocity. For the recognition, historical log for a certain period of time is used in addition to the current log. The behavior recognition unit 53 provides a node number of a current state node to the behavior prediction unit 54.

The behavior prediction unit 54 searches all the routes that the user may possibly take from the user's current location indicated by the node number of the state node provided by the behavior recognition unit 53 using the probabilistic state transition model of the parameters obtained through learning, and calculates a choice probability for each of the searched route. If destination/travel route/arrival time, and a plurality of destinations are predicted, this prediction would also predict each probability. If the probability of reaching the destination is high, it would assume the destination as a go-through point and predict further ahead destination candidates as a final destination. For behavior recognition and prediction, the maximum likelihood estimation algorithm, the Viterbi algorithm, or the Back-Propagation Through Time (BPTT) method is used.

In other words, the behavior recognition unit 53 and the behavior prediction unit 54 use parameters that learned not only the travel route but also even the behavior state by adding the time-series data of the moving velocity.

The destination prediction unit 55 predicts the user's destination using the probabilistic state transition model of parameters obtained through learning.

Specifically, the destination prediction unit 55, firstly, lists up destination candidates. The destination prediction unit 55 assumes locations, where the user's behavior state that is recognized is a stay state, as the destination candidates.

Further, the destination prediction unit 55 decides a destination candidate which is on the route searched by the behavior prediction unit 54 among the listed destination candidates, as the destination.

Subsequently, the destination prediction unit 55 calculates an arrival probability for each of the decide destination.

In a case where a lot of destinations are detected, if the display unit 18 displays all, it may be difficult to see them, or it may display even locations with low possibility to be reached. Therefore, as the searched routes are selected in the first embodiment, destinations subject to be displayed can also be selected so that only destination having an arrival probability more than a predetermined value would be displayed. Note that it does not matter if the numbers of destinations and routes to be displayed are different.

If the destination subject to be displayed is decided, the destination prediction unit 55 calculates an arrival time of the route to the destination, and causes the display unit 18 to display it.

If there are many routes for the destination, the destination prediction unit 55 can calculate an arrival time of only the route to be displayed after selecting a certain number of routes to the destination based on the choice probability.

Further, if there are many routes for the destination, other than deciding routes to be displayed in the order of higher possibility to be selected, it is possible to decide routes to be displayed in the order of shorter arrival time, or in the order of shorter distance to the destination. If deciding the routes to be displayed in the order of shorter arrival time, the destination prediction unit 55, for example, firstly calculates the arrival time of all routes to the destination, and decides the route to be displayed based on the calculated arrival time. If deciding the routes to be displayed in the order of shorter distance to the destination, the destination prediction unit 55, for example, firstly calculates the distance to the destination based on information on latitude/longitude corresponding to the state node regarding all the routes to the destination, and decide the routes to be displayed based on the calculated distance.

The operation unit 17 receives information on the distance that the user inputs, and provides it to the destination prediction unit 55. The display unit 18 displays information provided by the behavior learning unit 52 or the destination prediction unit 55.

[Hardware Configuration Example of the Prediction System]

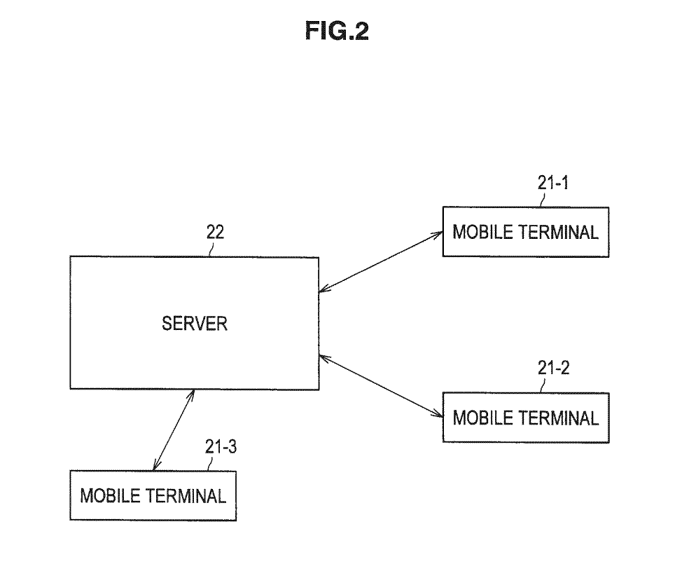

The prediction system 1 configured as described above can adapt, for example, a hardware configuration shown as FIG. 2. That is, FIG. 2 is a block diagram showing a hardware configuration example of the prediction system 1.

In FIG. 2, the prediction system 1 is configured by three mobile terminals 21-1 to 21-3 and a server 22. The mobile terminals 21-1 to 21-3 are same-type of the mobile terminal 21 having the same functions, however, each of the mobile terminals 21-1 to 21-3 is owned by a different user. Consequently, although FIG. 2 shows only three mobile terminals 21-1 to 21-3, however, there are the mobile terminals 21 for the number corresponding to the number of users.

The mobile terminal 21 can receive/transmit data to/from the server 22 through communication via a network such as a wireless communication and internet, or the like. The server 22 receives data transmitted from the mobile terminal 21, and performs predetermined processing on the data received. The server 22 transmits the result of data processing to the mobile terminal 21 via wireless communication, or the like.

Accordingly, the mobile terminal 21 and the server 22 have at least a communication unit that performs wireless or wired communication.

Further, it can adapt a configuration in which the mobile terminal 21 includes the GPS sensor 11, the operation unit 17 and the display unit 17 described in FIG. 1, and the server 22 includes the velocity calculation unit 50, the time-series data storage unit 51, the behavior learning unit 52, the \ behavior recognition unit 53, the behavior prediction unit 54, and the destination prediction unit 55.

If this configuration is adapted, in the learning processing, the mobile terminal 21 transmits the time-series data obtained by the GPS sensor 11. The server 22 learns the user's activity state by the probabilistic state transition model based on the received time-series data for learning. Further, in the prediction processing, the mobile terminal 21 transmits a destination specified by the user via the operation unit 17 as well as transmitting location data obtained in real-time by the GPS sensor 11. The server 22 recognized the user's current activity state, that is, the user's current location using parameters obtained through learning, and further transmits the specified routes and time to the destination to the mobile terminal 21 as the processing result. The mobile terminal 21 displays the processing result transmitted from the server 22 on the display unit 18.

Further, it can adapt a configuration in which the mobile terminal 21 includes the GPS sensor 11, the velocity calculation unit 50, the behavior recognition unit 53, the behavior prediction unit 54, the destination prediction unit 55, the operation unit 17, and the display unit 17 in FIG. 1, and the server 22 includes the time-series data storage unit 51 and the behavior learning unit 52 in FIG. 1.

If this configuration is adapted, in the learning processing, the mobile terminal 21 transmits the time-series data obtained by the GPS sensor 11. The server 22 learns the user's activity state by the probabilistic state transition model based on the received time-series data for learning, and transmits parameters obtained through learning to the mobile terminal 21. Further, in the prediction processing, the mobile terminal 21 recognizes user's current location using parameters received from the server 22 based on the location data obtained in real-time by the GPS sensor 11, and further, calculates route and time to the specified destination. Moreover, the mobile terminal 21 displays the route and time to the destination of the calculation result on the display unit 18.

The above roles sharing between the mobile terminal 21 and the server 22 can be determined according to each of processing capabilities as a data processing device and communication environment.

Although the learning processing takes an extremely long time for one processing, however, the processing is not necessarily processed so often. Therefore, since the server 22 generally has higher processing capability than the mobile terminal 21 which can be portable, it is possible to cause the server 22 to execute the learning processing (updating the parameters) based on the time-series data accumulated about once a day.

On the other hand, since it is preferable that the prediction processing is performed promptly corresponding to location data being updated from moment to moment in real-time for displaying, it is much preferable to be done by the mobile terminal 21. If the communication environment is rich, it is much preferable to make the server 22 to perform the prediction processing as well, as described above, and to receive the prediction result only from the server 22, reducing load on the mobile terminal 21 which is expected to be small and capable of being carried.

Further if the mobile terminal 21 by itself can perform the learning processing and prediction processing in high speed as a data processing apparatus, it is also possible that the mobile terminal 21 includes all of the configuration of the prediction system 1 in FIG. 1.

[Example of Time-Series Data Input]

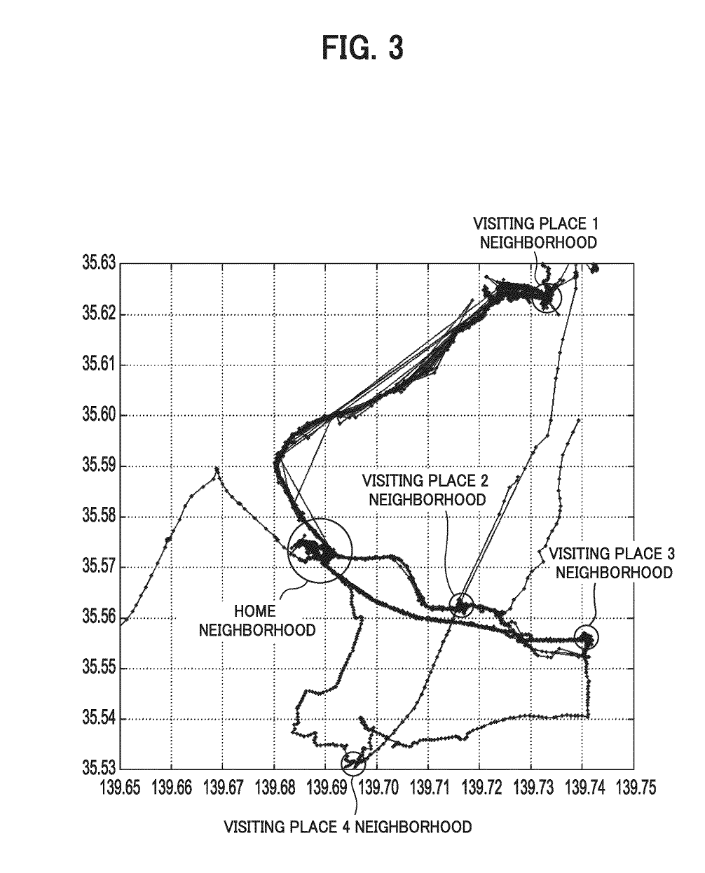

FIG. 3 shows an example of time-series data of location obtained by the prediction system 1. In FIG. 3, the horizontal axis represents longitude, and the vertical axis represents latitude.

The time-series data shown in FIG. 3 indicates time-series data of an experimenter that has been accumulated for about one month and a half. As shown in FIG. 3, the time-series data is mainly data of the travel between four visiting places, such as neighborhood of home, office, etc. Note that, this time-series data includes data in which some location data is skipped when it is difficult to catch the satellite.

The time-series data shown in FIG. 3 is also time-series data used as learning data in a later-described verification experiment.

[Ergodic HMM]

Next, the ergodic HMM which the prediction system 1 adapts as a learning model will be explained.

FIG. 4 shows an example of the HMM.

The HMM is a state transition model having a state and a state and a state transitioning.

FIG. 4 shows an example of the HMM in three states.

In FIG. 4 (same in the following figures), a circle represents a state and an arrow represents a state transition. Note that the state corresponds to the above-described user's activity state, and has the same definition as a state node.

Further, in FIG. 4, sᵢ (i=1,2,3 in FIG. 4) represents a state (node), aᵢⱼ represents a state transition probability from State s to State s. Further, bⱼ(x) represents an output probability density function observed an observed value x at a state transition to State sⱼ, and πᵢ represents an initial probability where State sᵢ, is an initial state.

Note that, as an output probability density function bⱼ(x), for example, a contaminated normal probability distribution, or the like is used.

Here, the HMM (successive HMM) can be defined by the state transition probability aᵢⱼ, the output probability density function bⱼ(x), and the initial probability πᵢ. Those the state transition probability aᵢⱼ, the output probability density function bⱼ(x), and the initial probability πᵢ are called the HMM parameter λ={aᵢⱼ,bⱼ(x), πᵢⱼ=1, 2, . . . , M, j=1, 2, . . . , M}. M represents the number of states of HMM.

As a method for estimating the HMM parameter λ, the Baum-Welch maximum likelihood estimation method has been broadly used. The Baum-Welch maximum likelihood estimation method is a method for estimating parameters based on the Expectation-Maximization algorithm (EM algorithm).

According to the Baum-Welch maximum likelihood estimation method, based on the time-series data x=x₁, x₂, . . . , x_{T} that is observed, the HMM parameter λ is estimated so as to maximize the likelihood calculated by an occurrence probability, which is a probability that the time-series data is observed (occurred). Here, xₜ represents signals (sample values) observed at Time t, and T represents length (the number of samples) of time-series data.

Regarding the Baum-Welch maximum likelihood estimation method, it is described in “Pattern Recognition and Machine Learning (Information Science and Statistics)”, p. 333, Christopher M. Bishop Springer, N.Y., 2006.)(hereinafter, referred to as Reference A), for example.

Although the Baum-Welch maximum likelihood estimation method is a method for estimating parameters based on the likelihood maximization, however, it does not ensure the optimality, and it may converge to a local solution depending upon the HMM configuration and the initial value of the parameter λ.

The HMM has been broadly used in voice recognition, and in the HMM used in the voice recognition, generally, the number of states, method for state transition, or the like is to be determined in advance.

FIG. 5 shows an example of HMM used for voice recognition;

The HMM in FIG. 5 is called a left-to-right type.

In FIG. 5, the number of states is three, and the state transition is restricted to a structure which allows only a self-transition (a state transition from State sᵢ to State sⱼ) and a state transition from left to immediate next right.

In contrast to the HMM with restrictions in the state transition like the HMM in FIG. 5, the HMM without restriction in the state transition, that is, the HMM capable of a state transition from an arbitrary state sᵢ to an arbitrary state sⱼ, is called the Ergodic HMM.

The Ergodic HMM is a HMM having the highest flexibility in its structure, however, if the number of states becomes large, it becomes difficult to estimate the parameter λ.

For example, when the number of states of the Ergodic HMM is 1000, the number of state transitions becomes 1,000,000 (=1000*1000).

Therefore, in this case, among the parameter λ, for example, regarding the state transition probability aᵢⱼ, 1,000,000 of the state transition probability aᵢⱼ has to be estimated.

For the state transition that is set to the state, it can put a restrict that is a sparse structure (a sparse restriction), for example.

Here, what the sparse structure is a structure having a restriction not on a tight state transition like the Ergodic HMM capable of a state transition from an arbitrary state to an arbitrary state, but having an extremely strict restriction on a state to transition from an arbitrary state. Note that it is assumed here that even a sparse structure has at least one state transition to another state, and has a self-transition.

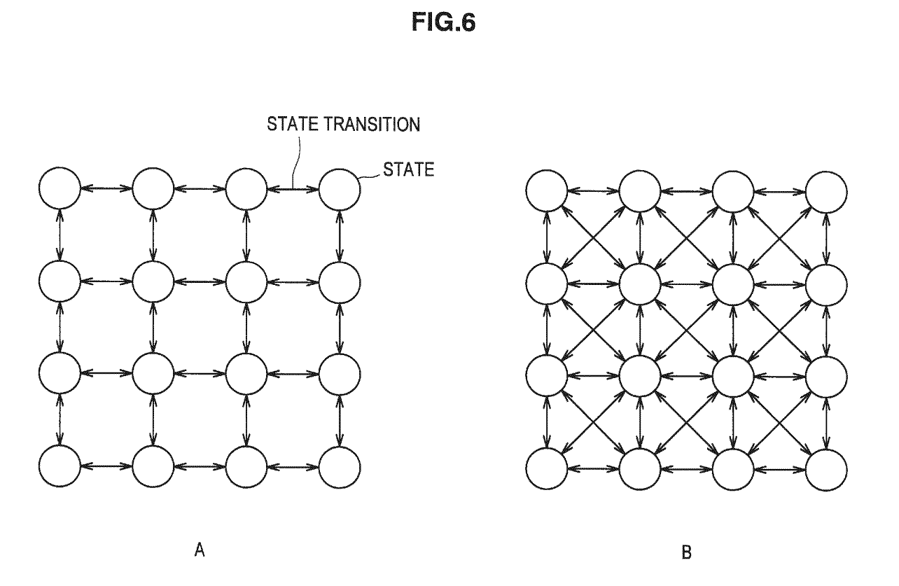

FIG. 6 shows an example of HMM given with a sparse restriction.

Here in FIG. 6, two-direction arrows connecting two states represent a state transition form one of the two states to another, and a state transition from the other to the one. Further, in FIG. 6, each state is capable of a self-transition, and illustrating arrows for representing the self-transition is omitted.

In FIG. 6, 16 of states are arranged in matrix on two-dimensional space. In other words, in FIG. 6, four states are arranged in a landscape direction, and four states are arranged in longitudinal direction.

Assuming direction between states next to each other in the landscape direction and direction between states next to each other in the longitudinal direction are 1, FIG. 6A shows the HMM with the sparse restriction which enables state transition to a state whose distance is equal to or less than 1, and which disables state transition to other states.

Further, FIG. 6B shows the HMM with the sparse restriction which enables state transition to a state whose distance is equal to or less than √2, and which disables state transition to other states.

In this embodiment, location data that the GPS sensor 11 obtained is supplied to the time-series data storage unit 51 as time-series data x=x₁, x₂, . . . , x_{T}. The behavior learning unit 52 estimates the parameter λ of HMM representing the user's activity model using the time-series data x=x₁, x₂, . . . , x_{T} stored in the time-series data storage unit 51.

Specifically, it is considered that data of location (latitude/longitude) at each time representing the user's travel route is an observed data of random variable normally-distributed to the extent of a predetermined dispersed value from a point on a map corresponding to any of the HMM State sⱼ. The behavior learning unit 52 optimizes a point on the map corresponding to each State sⱼ and its dispersed value, and the state transition probability aᵢⱼ.

The initial probability πi of State sᵢ can be set as the same value. For example, each of the initial probability πᵢ of M-state sᵢ is to be set as 1/M. Location data after executing predetermined processing, such as interpolation processing, to the location data that the GPS sensor 11 obtained can be provided to the time-series data storage unit 51 as the time-series data x=x₁, x₂, . . . , x_{T}.

The behavior recognition unit 53 applies the Vitarbi method to the user's activity model (HMM) obtained through learning, and calculates process of state transition (series of state) (path) where the location data x=x₁, x₂, . . . , x_{T} from the GPS sensor 11 makes the observed likelihood the largest (hereinafter, also referred to as likelihood path). This enables user's current activity state, that is, State sᵢ corresponding to the user's current location to be recognized.

Here, the Vitarbi method is an algorithm for deciding a path (maximum path) to maximize a value (occurrence probability) accumulated, through the length T of the time-series data x after processing, the state transition probability aᵢⱼ that transitions from State sᵢ to State sⱼ, and probability (output probability calculated from the output probability density function bⱼ(x)) where the sample value xₜ of Time t among the location data x=x₁, x₂, . . . , x_{T} is observed in the state transition, at Time t, among paths of state transition having each State sᵢ as a start point. The details of the Vitarbi method are described in p. 347 of the above-mentioned Reference A.

[Processing for Searching Routes by Behavior Prediction Unit 54]

Subsequently, processing for searching routes by the behavior prediction unit 54 will be explained.

It can be considered that each state sᵢ obtained through learning represents a prescribed point (location) on a map and that it represents a route for transitioning from State sᵢ and State sⱼ if State sᵢ and State sⱼ are connected.

In this case, each point corresponding to State sᵢ can be classified into any of an end point, a pass point, a branch point, or a loop. The end point is a point whose probabilities other than the one of self-transition is extremely small (probabilities other than the one of self-transition is equal to or less than a predetermined value), and which there is no other point to transition to next. The pass point is a point which there is a significant transition other than a self-transition, that is, there is a point to transition to next. The branch point is a point which there are two or more significant transitions other than a self-transition, that is, there are two or more points to transition to next. The loop is a point that is identical to any of the points on the routes that have been through.

When searching for a route to the destination, if there are different routes, it is expected to present information such as necessary time, or the like, on each of the routes. The following conditions are set for searching all the possible routes.

(1) If a route once branched, although the route merges again, the route is assumed as a different route.

(2) When an end point or a point included in the routes that has been through occurs, searching the route is ended.

The behavior prediction unit 54 repeats classifying points possible to be transitioned to as next location into any of end point, pass point, branch point or loop, with the user' current activity state recognized by the behavior recognition unit 53, that is the user's current point, as a starting point, until the end condition (2).

If the current point is classified as an end point, the behavior prediction unit 54 connects the current point to the route up to the current point at first, then ends searching this route.

On the other hand, if the current point is classified as a pass point, the behavior prediction unit 54 connects the current point to the route up to the current point first, then moves to the next point.

If the current point is classified as a branch point, the behavior prediction unit 54 connects the current point to the route up to the current point first, duplicates the routes up to the current point for the number of branches, and connects them with the branch point. After that, the behavior prediction unit 54 moves to one of the branch points as the next point.

If the current point is classified as a loop, the behavior prediction unit 54 ends searching this route without connecting the current point to the route up to the current point. Note that if it is a case where going back to immediate previous point along the route, the case is included in a loop, therefore, such case is not taken into consideration.

[Example of Processing for Searching]

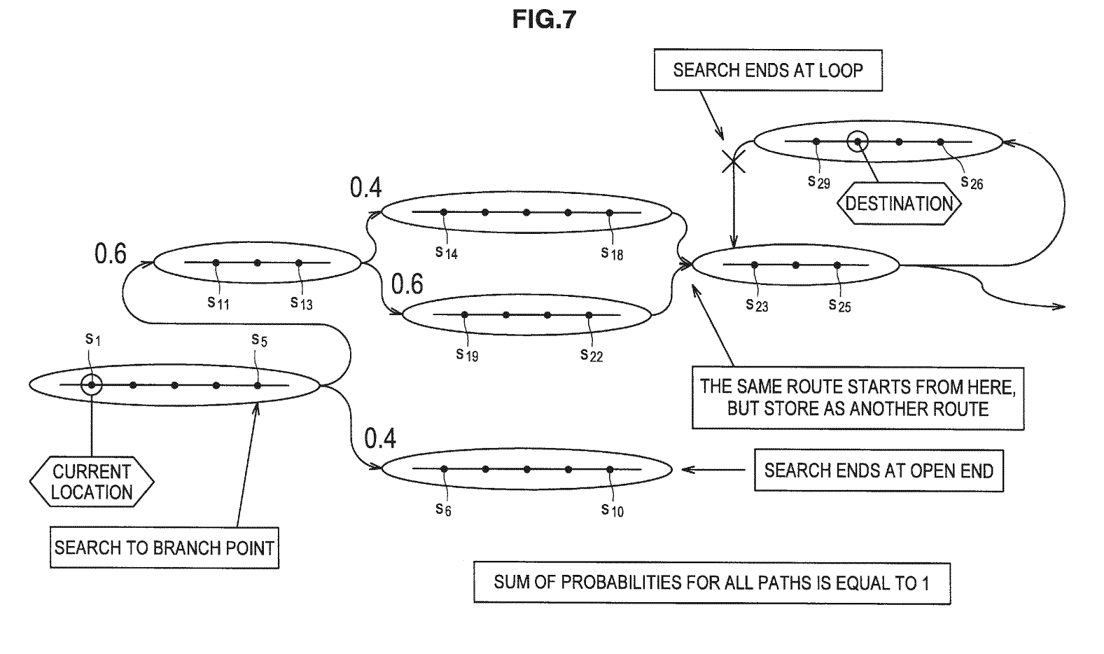

FIG. 7 shows an example of processing for searching routes by the behavior prediction unit 54.

In the example of FIG. 7, when state sₗ is the current location, three kinds of routes will be searched. The first route is a route starting from State s₁, going through State sₛ, State s₆, or the like, to State s₁₀ (hereinafter, also referred to as Route A). The second route is a route starting from State s₁, going through State sₛ, State s₁₁, State s₁₄, State s₂₃, or the like, to State s₂₉ (hereinafter, also referred to as Route B). The third route is a route starting from State s₁, going through State sₛ, State s₁₁, State s₁₉, State s₂₃, or the like, to State s₂₉ (hereinafter, also referred to as the Route C).

The behavior prediction unit 54 calculates a probability that each of the searched routes is selected (choice probability of route). The choice probability of the route can be calculated by sequentially multiplying transition probabilities between states configuring the route. However, only a case of transitioning to the next step is taken into consideration, and there is no necessity to consider a case of staying at the place. Therefore, the choice probability of the route can be calculated from the state transition probability aᵢⱼ of each route calculated through learning using the transition probability [aᵢⱼ] that has been standardized excluding a self-transition probability.

The transition probability [aᵢⱼ] standardized excluding a self-transition probability can be represented by the following formula (3).

$$[ {a}_{ij} ] = \frac{( 1 - {δ}_{ij} ) {a}_{ij}}{{\sum }_{j = 1}^{N} ( 1 - {δ}_{ij} ) {a}_{ij}} \qquad ( 3 )$$

Here, δ represents the Kronecker function, which is a function to get 1 only when the index i and j are identical, and 0 in other cases.

Accordingly, for example, when the state transition probability aᵢⱼ in FIG. 7 is self-transition probability a_{5,5}=0.5, transition probability a_{5,6}=0.2, transition probability a_{5,11}=0.3, if branching from State s₅ to State s₅ or State s₁₁, transition probability [a_{5,6}] and transition probability [a_{5,11}] become 0.4, and 0.6 respectively.

If the node number i of State sᵢ of the searched route is (y₁, y₂, . . . , yₙ), the choice probability of this route can be represented as the following formula (4) using the standardized transition probability [aᵢⱼ].

$$\begin{matrix}P ( {y}_{1} , {y}_{1} , … , {y}_{n} ) = [ {a}_{{y}_{1} {y}_{2}} ] [ {a}_{{y}_{2} {y}_{1}} ] … [ {a}_{{y}_{2} + {y}_{1}} ] \\ = {\prod }_{i = 1}^{n - 1} [ {a}_{{y}_{i} {y}_{i + 1}} ]\end{matrix} \qquad ( 4 )$$

In reality, since the standardized transition probability [aᵢⱼ] at a pass point is 1, it is enough to sequentially multiply the standardized transition probability [aᵢⱼ] at a time of branching.

In the example of FIG. 7, the choice probability of Route A is 0.4. The choice probability of Route B is 0.24=0.6*0.4. The choice probability of Route C is 0.36=0.6*0.6. Further, sum of the choice probabilities of the calculated routes is 1=0.4+0.24+0.36, and thus it can be understood that all the routes can be searched in just proportion.

As described above, each route searched based on the current location and its choice probability is to be provided from the behavior prediction unit 54 to the destination prediction unit 55.

The destination prediction unit 55 extracts routes including the destination from the routes searched by the behavior prediction unit 54, and predicts time for the destination for each route extracted.

For example, in the example of FIG. 7, among the searched three Routes A to C, routes including State s₂₈ that is the destination are Route B and Route C. The destination prediction unit 55 predicts time to reach at State s₂₈ that is the destination through Route B or Route C.

Note that in a case where there are many routes including the destination and it becomes difficult to see if all the routes are displayed, or the number of presenting routes are set to a predetermined number, routes to be displayed on the display unit 18 (hereinafter, also referred to as route to be displayed) has to be determined among all the routes including the destination. In such case, since choice probabilities of each route has been calculated in the behavior prediction unit 54, the destination prediction unit 55 can determine a predetermined number of routes as routes to be displayed in the order of higher choice probability.

It is assumed that the current location at the current time t₁ is in State S_{y1}, and routes determined at Time (t₁, t₂, . . . t_{g}) is (s₁, s₂, . . . s_{yg}). In other words, it is assumed that the node number i of State sᵢ of the determined route is (y₁, y₂, . . . y_{g}). Hereinafter, to make the explanation simpler, there may be a case where State sᵢ corresponding to a location is represented simply by its node number i.

Since the current location y₁ at the current time t₁ is fixed by recognition by the behavior recognition unit 53, the probability P_{y1} (t₁) whose current location at the current time t₁ is y₁;

P_{y1}(t₁)=1

Further, probability being in a state other than y₁ at the current time t₁ is 0.

Meanwhile, probability P_{yn} (tₙ) staying at node number yₙ at a predetermined time tₙ can be represented by

P_{yn}(tₙ)=P_{yn}(tₙ−1)A_{y}_{ₙ}_{y}_{ₙ}+P_{y}_{_{n−1}}(tₙ−1)A_{y}_{_{n−1}}_{y}_{ₙ} (5)

The first term of the right-hand side of formula (5) represents probability of a case of being originally stay at the location yₙ and making a self-transition, and the second term of the right-hand side represents probability of a case of being transitioned from the previous location yₙ₋₁ to the location yₙ. In the formula (5), unlike the calculation of the choice probability of routes, the state transition probability aᵢⱼ obtained through learning is to be used as it is.

Prediction value <t_{g}> of Time t_{g} when reaching at the destination y_{g} is represented as;

$$〈 {t}_{g} 〉 = {\sum }_{t} {t}_{g} ( \frac{{P}_{{x}_{x - 1}} ( {t}_{g - 1} - 1 ) {A}_{{x}_{g - 1} {x}_{g}}}{{\sum }_{i} {P}_{{x}_{g - 1}} ( {t}_{g} - 1 ) {A}_{{x}_{x - 1} {x}_{g}}} ) \qquad ( 6 )$$

using “probability of staying at location y_{g-1}, which is one previous from the destination y_{g}, at time t_{g-1} immediately before, and traveling to destination y_{g} at time t_{g}.

In other words, the prediction value <t_{g}> is represented by an expectation value of time from the current time until “when to move to State s_{yg} at Time t_{g} after staying in State s_{yg-1}, which is one previous before State s_{yg} at immediate previous Time t_{g-1}”.

The calculation represented by the formula (6) for the prediction value of arrival time to the destination according to the present embodiment should integrate (Σ) Time t. However, since a case where reaching at the destination passing though the route that loops is excluded for routes to be searched, it is possible to set an efficiently long interval as an integral interval. The integral interval in the formula (6) can be, for example, about one time or twice of the maximum travel time among the learned routes.

[User's Activity Model Learning Processing]

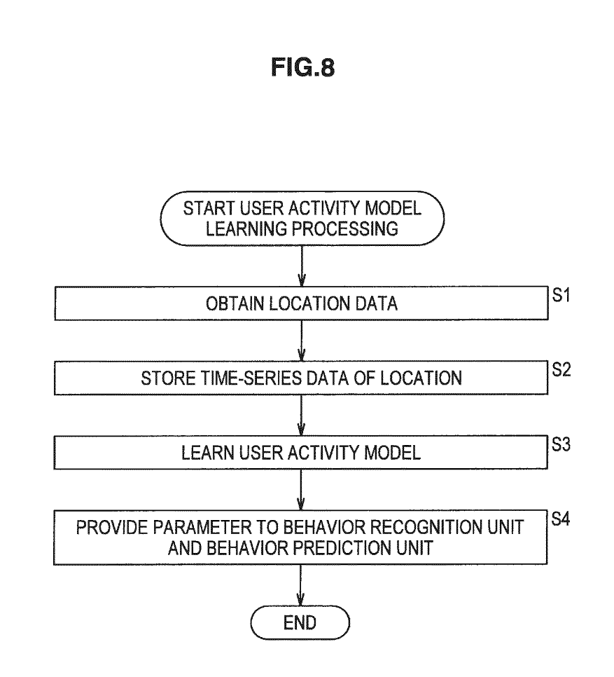

Subsequently, referring to a flowchart in FIG. 8, an explanation will be given on the user's activity model learning processing for learning the user's travel route as a probabilistic state transition model representing the user's activity state.

At first, in step S1, the GPS sensor 11 obtains location data to provide to the time-series data storage unit 51.

In step S2, the time-series data storage unit 51 stores the location data successively obtained by the GPS sensor 11, that is, the time-series data of location.

In step S3, the behavior learning unit 52 learns the user's activity model as a probabilistic state transition model based on the time-series data stored in the time-series data storage unit 51. In other words, the behavior learning unit 52 calculates of parameters of the probabilistic state transition model (user's activity model) based on the time-series data stored in the time-series data storage unit 51.

In step S4, the behavior learning unit 52 provides the parameters of the probabilistic state transition model calculated in step S3 to the behavior recognition unit 53, the behavior prediction unit 54, and the destination prediction unit 55, and ends the processing.

[The First Configuration Example of Behavior Learning Unit 52]

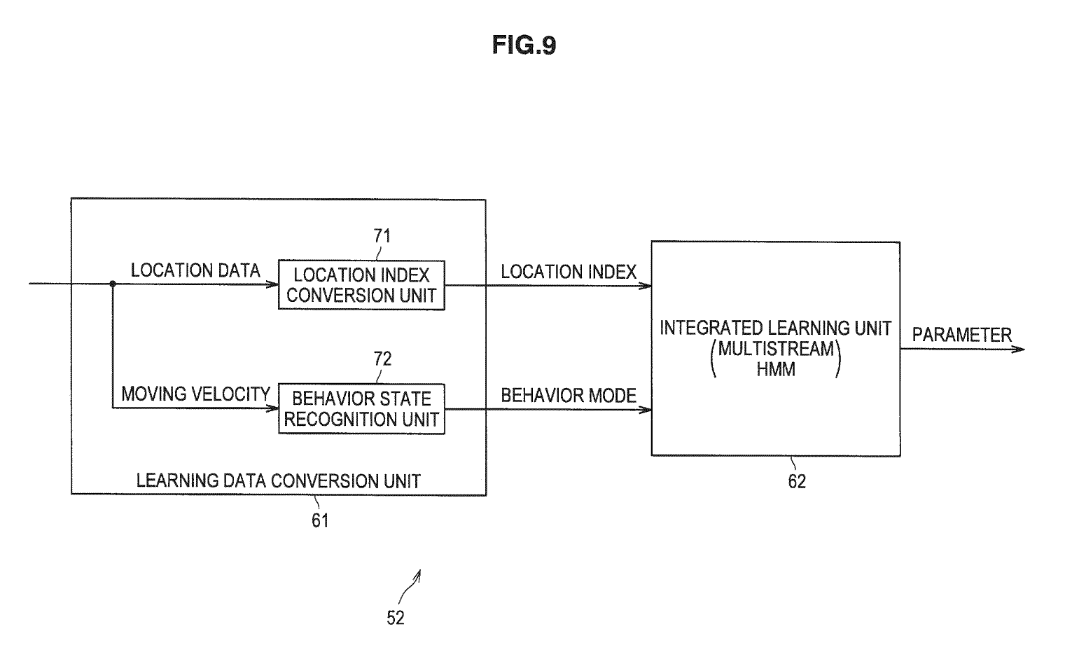

FIG. 9 is a block diagram showing the first configuration example of the behavior learning unit 52 in FIG. 1.

The behavior learning unit 52 learns both the user's travel route and behavior state at the same time using the time-series data of location and moving velocity stored in the time-series data storage unit 51 (shown in FIG. 1).

The behavior learning unit 52 includes a learning data conversion unit 61 and an integrated learning unit 62.

The learning data conversion unit 61 is configured from the a location index conversion unit 71 and a behavior state recognition unit 72, converts data of location and moving velocity provided by the time-series data storage unit 51 into data of location index and behavior mode, and provides it to the integrated learning unit 62.

The time-series data of location provided by the time-series data storage unit 51 is to be provided to the location index conversion unit 71. The location index conversion unit 71 can adapt a structure same as the behavior recognition unit 53 in FIG. 1. Accordingly, the location index conversion unit 71 recognizes user's current activity state corresponding to the user's current location from the user's activity model based on the parameters obtained through learning. The location index conversion unit 71 provides the node number, of the user's current state node to the integrated learning unit 62 as an index indicating location (location index).

As a learning device that learns parameters adapted by the location index conversion unit 71, a structure of the behavior learning unit 52 in FIG. 1, that is a learning device for the behavior recognition unit 53 in FIG. 1, can be adapted.

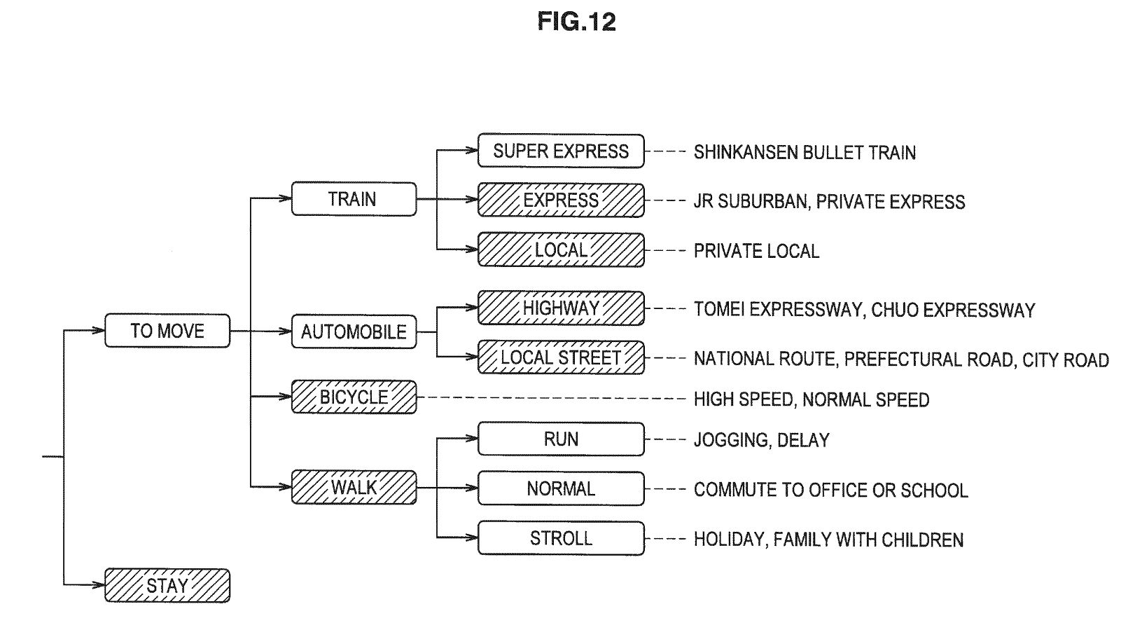

The time-series data of moving velocity provided by the time-series data storage unit 51 is to be provided to the behavior state recognition unit 72. The behavior state recognition unit 72 recognizes the user's behavior state corresponding to the provided moving velocity using the parameters obtained by learning the user's behavior state as the probabilistic state transition model, and provides the recognition result to the integrated learning unit 62 as behavior mode. As user's behavior state recognized by the behavior state recognition unit 72, at least stay state and behavior state have to exist. In the present embodiment, as later-described referring to FIG. 12, or the like, the behavior state recognition unit 72 provides behavior modes which is the travel state further classified into means of traveling, such as walking, bicycle, automobile, or the like, to the integrated learning unit 62.

Therefore, the integrated learning unit 62 is provided with the time-series discrete data that adapts the location index corresponding to location on a map as symbol, and the time-series discrete data that adapts behavior mode as symbol by the integrated learning unit 61.

Using the time-series discrete data that adapts the location index corresponding to location on a map as symbol and the time-series discrete data that adapts behavior mode as symbol, the integrated learning unit 62 learns the user's activity state by the probabilistic state transition model. Specifically, the integrated learning unit 62 learns parameter λ of multistream HMM that indicates the user's activity state.

Here, the multistream HMM is a HMM in which data following a plurality of different probability rules is output from a state node having transition probability same as an ordinary HMM. In the multistream HMM, among the parameter λ, the output probability density function bⱼ(x) is prepared for each of the time-series data separately.

In the present embodiment, since there are two types of time-series data; the time-series data of the location index and the time-series data of the behavior mode, the output probability density function b1ⱼ(x) in which the output probability density function bⱼ(x) corresponds to the time-series data of the location index, and the output probability density function b2ⱼ(x) in which the output probability density function bⱼ(x) corresponds to the time-series data of the behavior mode are prepared. The output probability density function b1ⱼ(x) is a probability which an index on a map becomes x when the state node of multistream HMM is j. The output probability density function b2ⱼ(x) is a probability which a behavior mode becomes x when the state node of multistream HMM is j. Therefore, in the multistream HMM, user's activity state is learned (integrated learning) in a manner that an index on a map and a behavior mode is associated with each other.

Specifically, the integrated learning unit 62 learns the probability of the location index output by each state node (probability which location index is to be output), and the probability of behavior mode output by each state node (probability which behavior mode is to be output). According to an integrated model (multistream HMM) obtained through learning, state nodes which likely output behavior modes in “stay state” probabilistically. By calculating location index from the recognized state node, location index of destination candidates can be recognized. Further, location of the destination can be recognized from a latitude/longitude distribution that the location index of the destination candidate indicates.

As described above, it is estimated that user's staying place is in a position indicated by the location index corresponding to a state node with high probability that behavior mode to be observed becomes in “stay state”. Further, as described above, places to be in “stay state” is often a destination, therefore, this staying place can be estimated as the destination.

The integrated learning unit 62 provides parameter λ of multistream HMM that indicates user's activity state to the behavior recognition unit 53, the behavior prediction unit 54, and the destination prediction unit 55.

[The Second Configuration Example of Behavior Learning Unit 52]

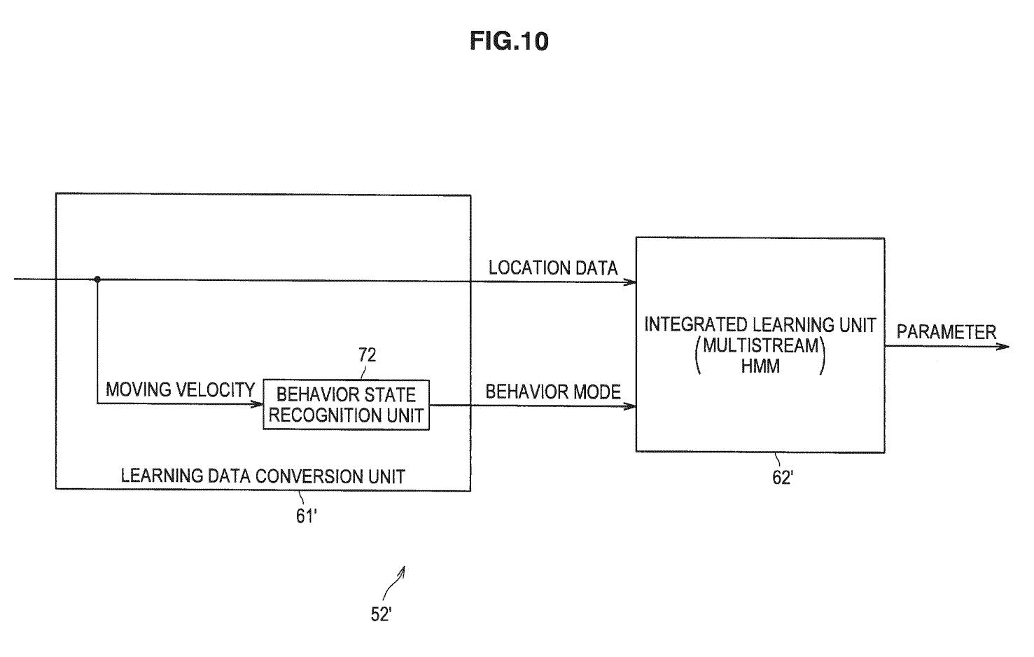

FIG. 10 is a block diagram showing a second configuration example of a behavior learning unit 52 in FIG. 1.

The behavior learning unit 52 in FIG. 10 includes a learning data conversion unit 61′ and an integrated learning unit 62′.

The learning data conversion unit 61′ includes the behavior state recognition unit 72 only same as the learning data conversion unit 61 in FIG. 9. In the learning data conversion unit 61′, location data provided by the time-series data storage unit 51 is to be provided into the integrated learning unit 62′ as it is. On the other hand, data of moving velocity provided by the time-series data storage unit 51 is to be converted into behavior mode by the behavior state recognition unit 72 and to be provided to the integrated learning unit 62′.

In the first configuration example of the behavior learning unit 52 in FIG. 9, location data is converted into the location index, therefore, in the integrated learning unit 62, likelihood of the learning model (HMM) is not reflected by information on being close or distant on a map. On the contrary, in the second configuration example of the behavior learning unit 52 in FIG. 10, providing the location data to the integrated learning unit 62′ as it is enables such information on distance to reflect in the likelihood of the learning model (HMM).

Moreover, in the first configuration example, two-stage learning is necessary; one is learning of the user's activity model (HMM) in the location index conversion unit 71 and the behavior state recognition unit 72, and another is learning of the user's activity model in the integrated learning unit 62. In the second configuration example, learning of the user's activity model in the location index conversion unit 71 is not necessary, at least, and this reduces the load on the calculation processing.

On the other hand, since the first configuration example converts into index, it does not matter what the data before conversion is, not only location data, however, since the second configuration example limits to location data, it could say that the versatility fails.

Using the time-series data of location and the time-series discrete data that adapts the behavior mode as symbol, the integrated learning unit 62′ learns the user's activity state by the probabilistic state transition model (multistream HMM). Specifically, the integrated learning unit 62′ learns distributional parameters of latitude/longitude output from each state node, and probabilities of behavior mode.

According to an integrated model (multistream HMM) obtained through learning by the integrated learning unit 62′, state nodes which likely output behavior modes in “stay state” probabilistically. The latitude/longitude distribution can be calculated from the calculated state nodes. Further, location of the destination can be calculated from the latitude/longitude distribution.

As described above, it is estimated that user's staying place is in a location indicated by the latitude/longitude distribution corresponding to a state node with high probability that behavior mode to be observed becomes in “stay state”. Further, as described above, places to be in “stay state” is often a destination, therefore, the staying place can be estimated as the destination.

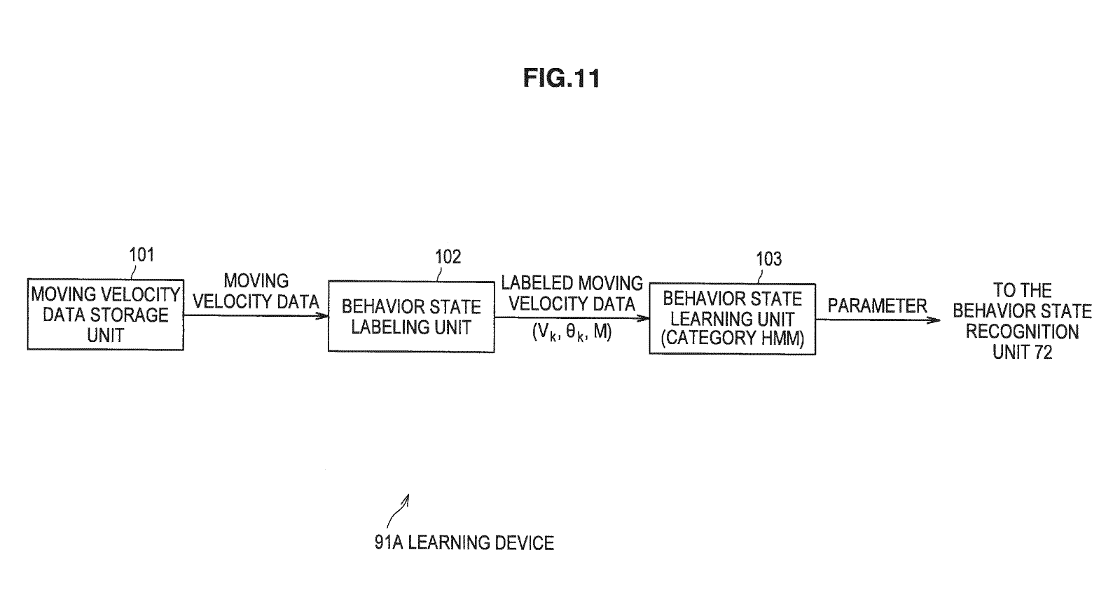

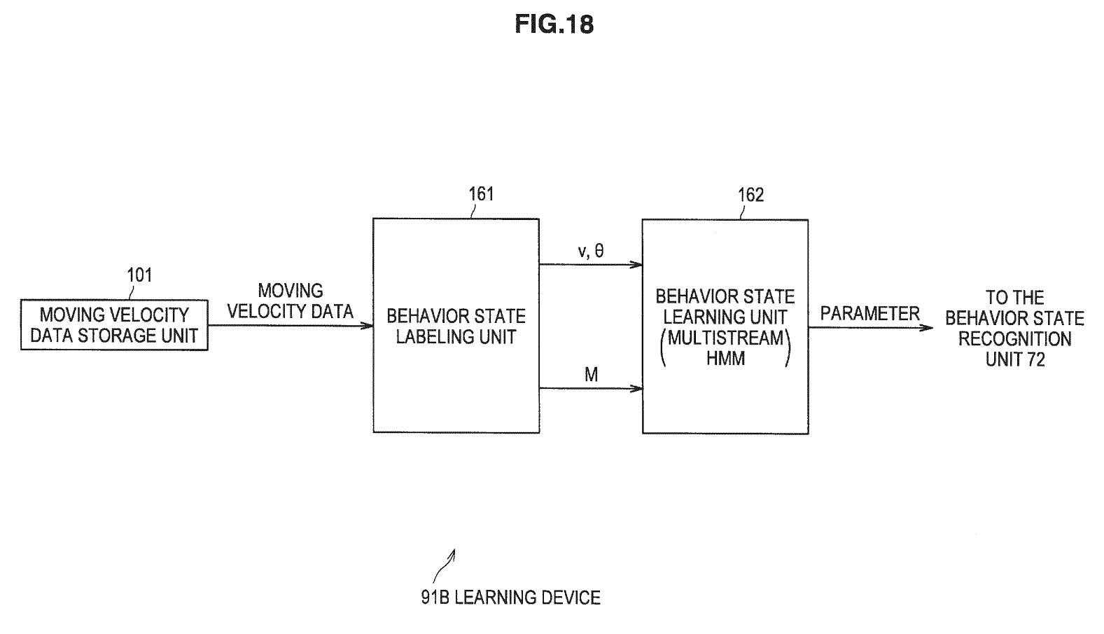

Next, an explanation will be given on a configuration example of a learning device that learns parameters of the user's activity model (HMM) used in the behavior state recognition unit 72 in FIG. 9 and FIG. 10. Hereinafter, as the configuration example of the learning device of the behavior state recognition unit 72, examples of a learning device 91A (FIG. 11) that learns by the category HMM and a learning device 91B (FIG. 18) that learns by the multistream HMM will be explained.

[The First Configuration Example of Learning Device of Behavior State Recognition Unit 72]

FIG. 11 shows a configuration example of the learning device 91A that learns parameters of the user's activity model used in the behavior state recognition unit 72 by the category HMM.

In the category HMM, it is well-known to which category (class) teacher data to be learned belongs, and HMM parameters is learned by category.

The learning device 91A includes a moving velocity data storage unit 101, a behavior state labeling unit 102, and a behavior state learning unit 103.

The moving velocity data storage unit 101 stores time-series data of moving velocity provided by the time-series data storage unit 51 (FIG. 1).

The behavior state labeling unit 102 assigns user's behavior state as label (category) to the moving velocity data sequentially provided in time series by the moving velocity data storage unit 101. The behavior state labeling unit 102 provides labeled moving velocity data, which is moving velocity data corresponded to behavior state, to the behavior state learning unit 103. For example, regarding moving velocity vₖ and traveling direction θₖ at k-th step, data assigned with a label M indicating behavior state is provided to the behavior state learning unit 103.

The behavior state learning unit 103 classifies the labeled moving velocity data provided by the behavior state labeling unit 102 by category, and learns parameters of the user's activity model (HMM) by category. The parameters by category obtained as the result of learning is to be provided to the behavior state recognition unit 72 in FIG. 1 or FIG. 9.

[Classification Example of Behavior State]

FIG. 12 is showing a classification example of a behavior state in case of classifying by category.

As shown in FIG. 12, the user's behavior status can be classified into a stay state and travel state. In the present embodiment, as the user's behavior state that the behavior state recognition unit 72 recognizes, at least the stay state and the travel state should exist, therefore, these two classifications is necessary.

Further, the travel state can be classified by its travel means into a train, an automobile (including a bus, or the like), a bicycle, and walk. Train further can be classified into super-express, express, local, or the like, while automobile further can be classified into highway, local street, or the like. Moreover, walk can be classified into run, normal, stroll, or the like.

In the present embodiment, the user's behavior states are to be classified into “stay”, “train (express)”, “train (local)”, “automobile (highway)”, “automobile (local street)”, “bicycle”, and “walk”, which are indicated by shaded area. Note that “train (super express)” is omitted since no learning data has been obtained.

Needless to say, the way of category classification is not limited to the example in FIG. 12. Since changes in the moving velocity by the travel means does not differ depending on users, the time-series data of moving velocity as learning data is not necessarily for the user subject to be recognized.

[Processing Example of Behavior State Labeling Unit 102]

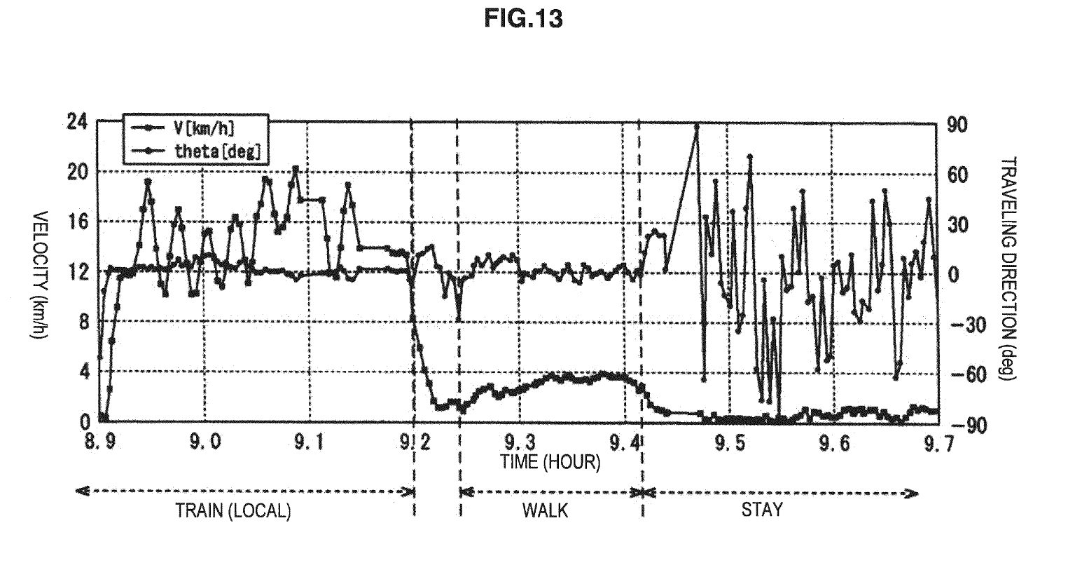

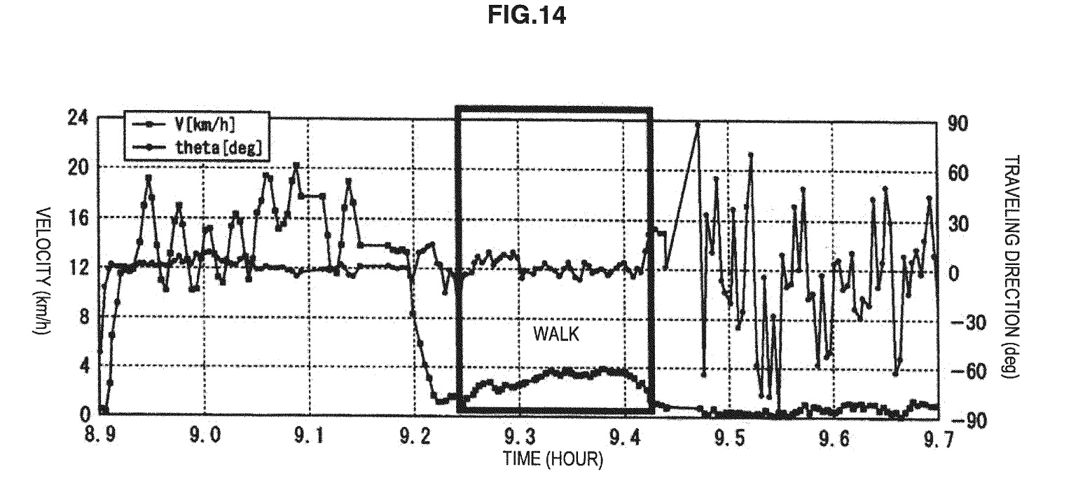

With reference to FIG. 13 and FIG. 14, an explanation will be given on processing example of the behavior state labeling unit 102.

FIG. 13 shows a processing example of time-series data of moving velocity to be provided to the behavior state labeling unit 102.

In FIG. 13, data of moving velocity (v,θ) provided by the behavior state labeling unit 102 is represented in the form of (t,v) and (t, θ). In FIG. 13, a plot of black square represents the moving velocity v, and a plot of circle represents the traveling direction θ. Further, the horizontal axis represents the time t, and the vertical axis on the right hand side represents the traveling direction θ, the vertical axis on the left hand side represents the moving velocity v.

Letters of “train (local)”, “walk”, and “stay” described in the lower side on the time axis in FIG. 13 are added for explanation. The time-series data in FIG. 13 starts with data of moving velocity in a case when the user is traveling by train (local), and next one is in a case when the user is traveling by “walk”, and next one is “stay”.

When the user is traveling by “train (local)”, the train stops at a station, the train accelerates when starts, and slows down again to stop at a station, and repeats them. Therefore, the data shows a feature that the plot of the moving velocity v repeatedly swings up and down. Note that the reason why the moving velocity is not 0 even when the train stops is a filtering processing has been executed by moving average.

It is most difficult to distinguish between the case when the user travels by “walk” and the case when the user stays. However, by the filtering processing by the moving average, there is a clear difference in the moving velocity v. Further, as for “stay”, there is recognized feature that the traveling direction θ changes drastically at moment, and it is recognized differentiation from “walk” is easy. Thus, by the filtering processing by moving average, and by representing the user's travel by the moving velocity v and the traveling direction θ, it becomes easy to distinguish between “walk” and “stay”.

A part between “train (local)” and “walk” is a part which is vague on which point the behavior has been switched due to the filtering processing.

FIG. 14 shows an example of labeling to the time-series data.

For example, the behavior state labeling unit 102 displays the data of the moving velocity illustrated in FIG. 13 on a display. The user performs an operation to specify a part to be labeled among the data of the moving velocity displayed on the display, by surrounding the part with a rectangular region, using a mouse, or the like. Further, the user inputs a label to assign to the specified data by a keyboard, or the like. The behavior state labeling unit 102 labels the data of the moving velocity included in the rectangular region specified by the user, by assigning the input label.

In FIG. 14, an example of illustrating the data of the moving velocity of the part corresponding to “walk” by a rectangular region. At this time, as for a part where behavior switches is vague due to the filtering processing, it is possible no to include the part into the region specified. Length of the time-series data is determined so as to make the time-series data clear in difference in behavior. For example, it can be determined about 20 steps (15 seconds*20 steps=300 seconds).

[The Configuration Example of Behavior State Learning Unit 103]

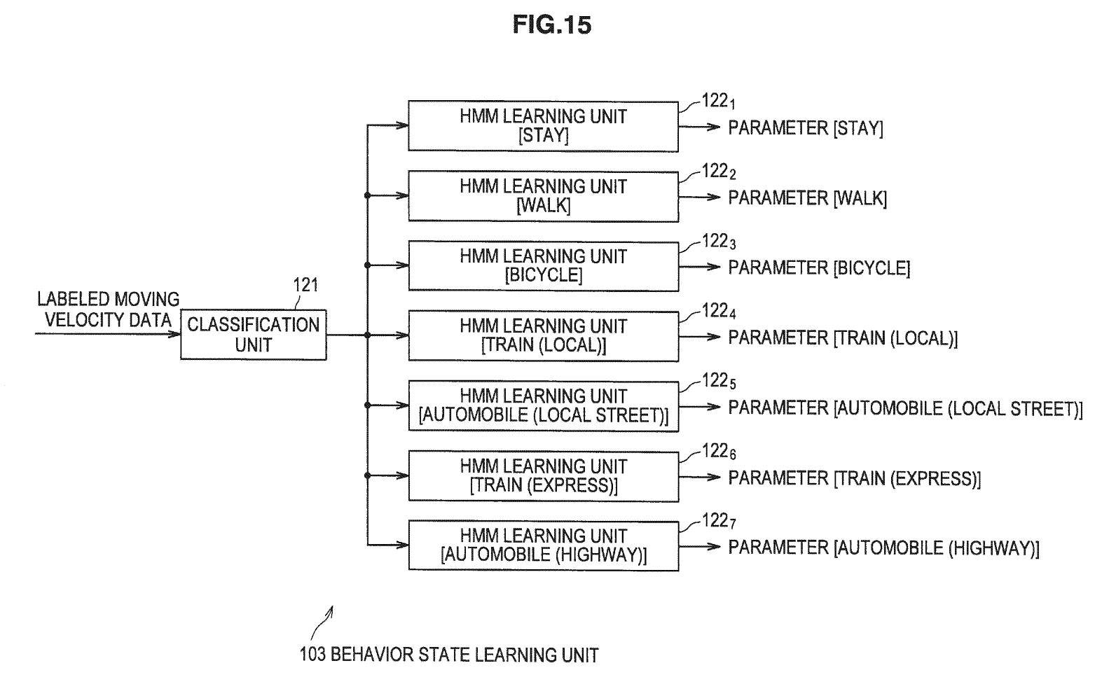

FIG. 15 is a block diagram showing a configuration example of the behavior state learning unit 103 in FIG. 11.

The behavior state learning unit 130 is configured by a classification unit 121, HMM learning units 122₁ to 122₇.

The classification unit 121 refers to a label of the labeled moving velocity data provided by the behavior state labeling unit 102, and provides it any of the HMM learning units 122₁ to 122₇ corresponding to the label. In other words, the behavior state learning unit 103 prepares the HMM learning unit 122 for each label (category), and the labeled moving velocity data provided by the behavior state labeling unit 102 is classified by label to be provided.

Each of the HMM learning units 122₁ to 122₇ uses the labeled moving velocity data provided, and learns a learning model (HMM). And each of the HMM learning units 122₁ to 122₇ provides the HMM parameter λ obtained through learning to the behavior state recognition unit 72 in FIG. 1 or FIG. 9.

The HMM learning unit 122₁ learns the learning model (HMM) in a case where the label is “stay”. The HMM learning unit 122₂ learns the learning model (HMM) in a case where the label is “walk”. The HMM learning unit 122₃ learns the learning model (HMM) in a case where the label is “bicycle”. The HMM learning unit 122₄ learns the learning model (HMM) in a case where the label is “train (local)”. The HMM learning unit 122₅ learns the learning model (HMM) in a case where the label is “automobile (local street)”. The HMM learning unit 122₆ learns the learning model (HMM) in a case where the label is “train (express)”. The HMM learning unit 122₇ learns the learning model (HMM) in a case where the label is “automobile (highway)”.

[Example of Learning Result]

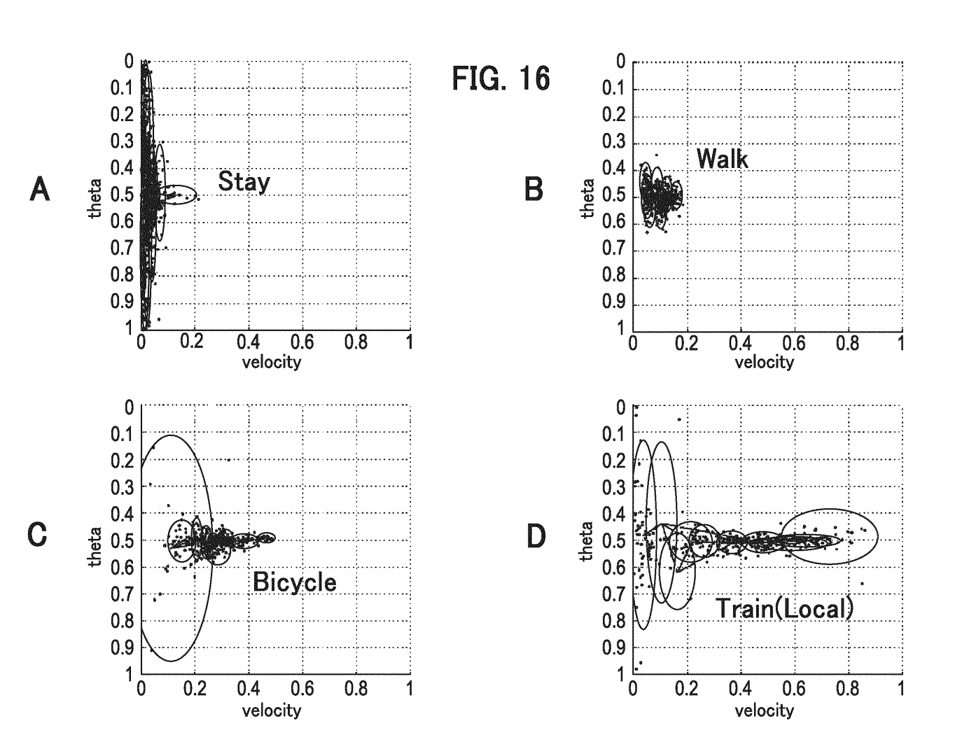

FIG. 16 shows a part of learning results by the behavior state learning unit 103.

FIG. 16A shows the learning result of the HMM learning unit 122₁, that is, the learning result when the label is “stay”. FIG. 16B shows the learning result of the HMM learning unit 122₂, that is, the learning result when the label is “walk”.

FIG. 16C shows the learning result of the HMM learning unit 122₃, that is, the learning result when the label is “bicycle”. FIG. 16D shows the learning result of the HMM learning unit 122₄, that is, the learning result when the label is “train (local)”.

In the FIG. 16A to FIG. 16D, the horizontal axis represents the moving velocity v, the vertical axis represents the traveling direction θ, and each point plotted on the graph represents the provided learning data. Further, an ellipse on the graph represents a state node obtained through learning, and density of distribution of each of the contaminated normal probability distribution is the same. Therefore, distribution of state node illustrated in a large ellipse is relatively large.

Regarding the moving velocity data in a case where the label is “stay” shown in FIG. 16A, the moving velocity v centers around 0, and the traveling direction θ spreads to the entire range, showing the data varies widely.

On the other hand, as shown in FIG. 16B to FIG. 16D, in a case where the label is “walk”, “bicycle”, or “train (local)”, the traveling direction θ varies small. Therefore, paying attention to how the traveling direction θ varies tells that it is possible to largely classify the stay state and the travel state.

Further, each of “walk”, “bicycle”, and “train (local)” in the travel state varies in its moving velocity v, and the features are shown in the graph. “walk” and “bicycle” often runs at a certain speed, while “train (local)” varies in its direction of velocity since changes in the velocity is large.

The ellipse illustrated in FIG. 16A to FIG. 16D as the learning results shows in a shape with a feature of each plot of category as described above, and it is considered that each behavior state is learned accurately.

[The First Configuration Example of Behavior State Recognition Unit 72]

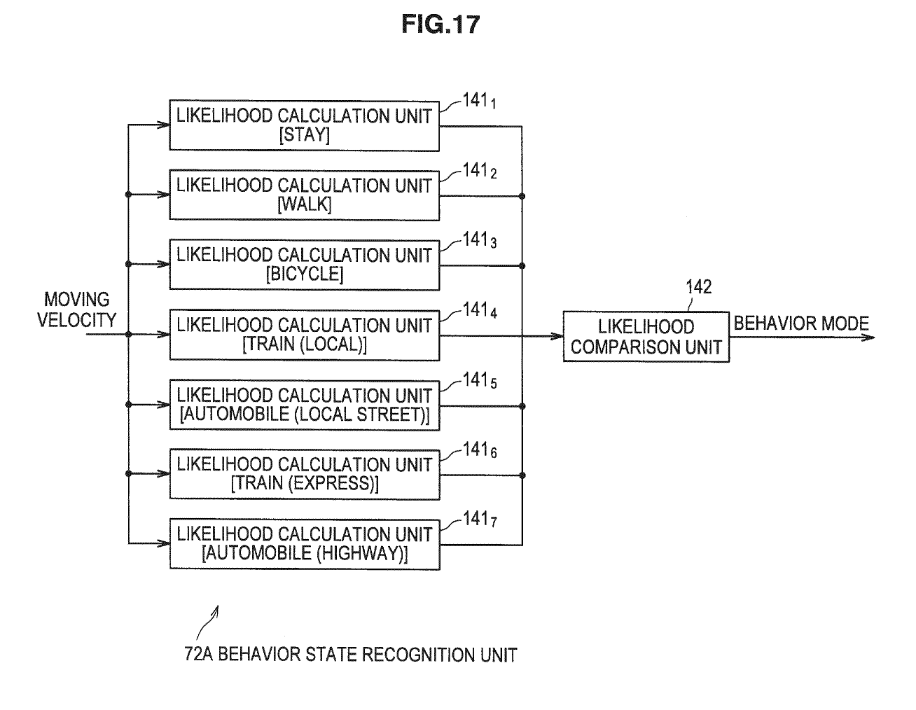

FIG. 17 is a block diagram showing a configuration example of a behavior state recognition unit 72A, which is the behavior state recognition unit 72 in a case of using parameters learned in the learning device 91A.

The behavior state recognition unit 72A is configured from the likelihood calculation unit 141₁ to 141₇, and the likelihood comparison unit 142.

The likelihood calculation unit 141₁ calculates the likelihood to the time-series data of the moving velocity provided by the time-series data storage unit 51, using parameters obtained through the HMM learning unit 122₁. In other words, the likelihood calculation unit 141₁ calculates the likelihood whose behavior state is “stay”.

The likelihood calculation unit 141₂ calculates the likelihood to the time-series data of the moving velocity provided by the time-series data storage unit 51, using parameters obtained through the HMM learning unit 122₂. In other words, the likelihood calculation unit 141₂ calculates the likelihood whose behavior state is “walk”.

The likelihood calculation unit 141₃ calculates the likelihood to the time-series data of the moving velocity provided by the time-series data storage unit 51, using parameters obtained through the HMM learning unit 122₃. In other words, the likelihood calculation unit 141₃ calculates the likelihood whose behavior state is “bicycle”.

The likelihood calculation unit 141₄ calculates the likelihood to the time-series data of the moving velocity provided by the time-series data storage unit 51, using parameters obtained through the HMM learning unit 122₄. In other words, the likelihood calculation unit 141₄ calculates the likelihood whose behavior state is “train (local)”.

The likelihood calculation unit 141₅ calculates the likelihood to the time-series data of the moving velocity provided by the time-series data storage unit 51, using parameters obtained through the HMM learning unit 122₅. In other words, the likelihood calculation unit 141₅ calculates the likelihood whose behavior state is “automobile (local street)”.

The likelihood calculation unit 141₆ calculates the likelihood to the time-series data of the moving velocity provided by the time-series data storage unit 51, using parameters obtained through the HMM learning unit 122₆. In other words, the likelihood calculation unit 141₆ calculates the likelihood whose behavior state is “stay”.

The likelihood calculation unit 141₇ calculates the likelihood to the time-series data of the moving velocity provided by the time-series data storage unit 51, using parameters obtained through the HMM learning unit 122₇. In other words, the likelihood calculation unit 141₇ calculates the likelihood whose behavior state is “stay”.

The likelihood comparison unit 142 compares likelihoods provided each of the likelihood calculation units 141₁ to 141₇, selects a behavior state with the highest likelihood, and outputs it as a behavior mode.

[The Second Configuration Example of Learning Device of Behavior State Recognition Unit 72]

FIG. 18 shows a configuration example of the learning device 91B that learns parameters of the user's activity model used in the behavior state recognition unit 72 by the multistream HMM.

The learning device 91A is configured from the moving velocity data storage unit 101, a behavior state labeling unit 161, and a behavior state learning unit 162.

The behavior state labeling unit 161 assigns user's behavior state as label (behavior mode) to the moving velocity data sequentially provided in time series by the moving velocity data storage unit 101. The behavior state labeling unit 161 provides the behavior state learning unit 162 with the time-series data of moving velocity (v, θ), and the time-series data of behavior mode M associated with the time-series data of moving velocity (v, θ).

The behavior state learning unit 162 learns the user's behavior state by the multistream HMM. In the multistream HMM, it is possible to learn associating time-series data (stream) of different kinds with each other. The behavior state learning unit 162 is provided with the time-series data of the moving velocity v and the traveling direction θ which is continuous volume, and the time-series data of the behavior mode which is dispersion volume. The behavior state learning unit 162 learns distributional parameters of the moving velocity output from each state node, and the probability of the behavior mode. According to the multistream HMM obtained through learning, it is possible to calculate the current state node, for example, from the time-series data of the moving velocity. Subsequently, it is possible to recognize the behavior mode by the calculated state node.

In the first configuration example using the category HMM, 7 HMM is necessary to be prepared for each category, however, in the multistream HMM, one HMM is enough. The number of the state node, however, needs to be prepared approximately as many as the number of the state node used for 7 categories.

[The Processing Example of Behavior State Labeling Unit 161]

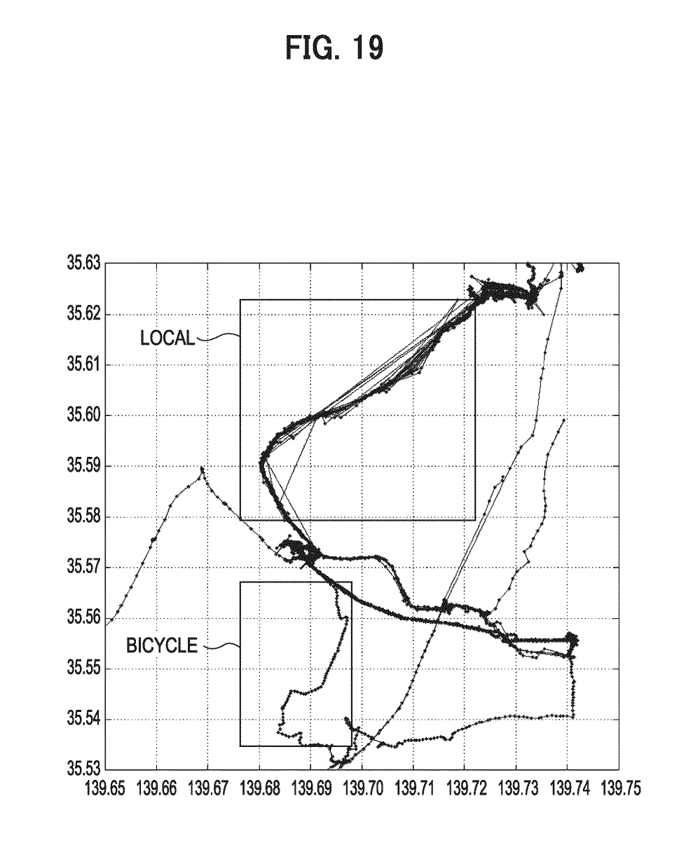

With reference to FIG. 19, an explanation will be given on a processing example of the behavior state labeling unit 161.

The method of labeling by the behavior state labeling unit 102 in the above-described first configuration example loses information on transition of travel means. Therefore, there may be a case where some transition of travel means appear in an unusual way. The behavior state labeling unit 161 assigns a label of the user's behavior state to the moving velocity data without losing information on transition of travel means.

Specifically, it is easier for the user to understand what kind of behavior the user took at a certain place not by looking at the moving velocity but the place (location). So, the behavior state labeling unit 161 presents the user with the location data corresponding to the time-series data of moving velocity, and labels a behavior state to the time-series data of moving velocity by assigning the label to the location.

In the example of FIG. 19, location data corresponding to the time-series data of moving velocity is illustrated on the map in which the horizontal axis represents the longitude, and the vertical axis represents the latitude. The user performs an operation to specify a place corresponding to a certain behavior state by surrounding the part with a rectangular region, using a mouse, or the like. Further, the user inputs a label to assign to the specified region by a keyboard, or the like. The behavior state labeling unit 161 labels by assigning the input label to the time-series data of the moving velocity corresponding to a location plotted in the rectangular region.

FIG. 19 shows an example of specifying parts corresponding to “train (local)” and “bicycle” with rectangular region.

Note that in FIG. 19, all the input time-series data is shown, however, if the number of data is a lot, it is possible to adapt a method in which every 20 steps are to be displayed at a time, and labeling the data displayed is sequentially repeated. Further, it may be good to prepare an application that the user can look back data in the past for himself/herself and label like a diary. In short, the method of labeling is not particularly limited. Further, labeling is not necessarily done by an exact person who made the data.

[Example of Learning Results]

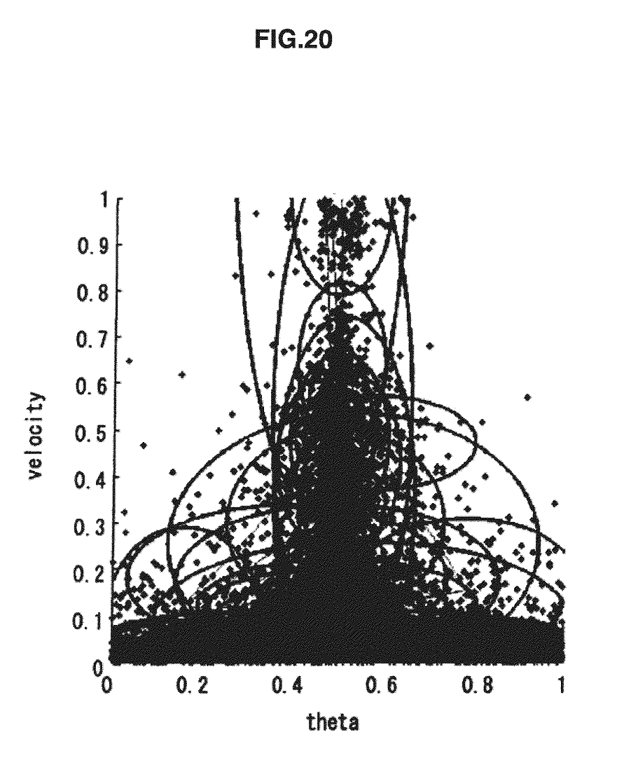

FIG. 20 shows learning results by the behavior state learning unit 162.

In the FIG. 20, the horizontal axis represents the traveling direction θ, the vertical axis represents the moving velocity v, and each point plotted on the graph represents the provided learning data. Further, an ellipse on the graph represents a state node obtained through learning, and density of distribution of each of the contaminated normal probability distribution is the same. Therefore, distribution of state node illustrated in a large ellipse is relatively large. The state node of FIG. 20 corresponds to the moving velocity. FIG. 20 does not show information on the behavior mode, however, each state node learns in association with observation probability of each behavior mode.

[The Second Configuration Example of Behavior State Recognition Unit 72]

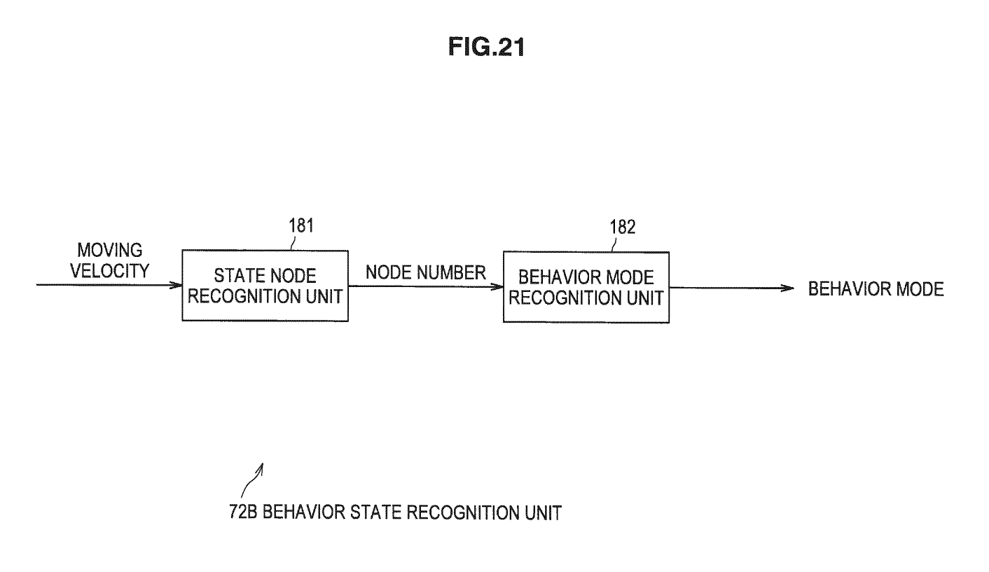

FIG. 21 is a block diagram showing a configuration example of a behavior state recognition unit 72B, which is the behavior state recognition unit 72 in a case of using parameters learned in the learning device 91B.

The behavior state recognition unit 72B is configured from a state node recognition unit 181 and a behavior mode recognition unit 182.

The state node recognition unit 181 recognizes a state node of the multistream HMM from the time-series data of moving velocity provided by the time-series data storage unit 51, using the parameters of the multistream HMM learned by the learning device 91B. The state node recognition unit 181 provides the behavior mode recognition unit 182 with the node number of the current state node that has been recognized.

The behavior mode recognition unit 182 recognizes a behavior mode with the highest probability among the state nodes recognized by the state node recognition unit 181 as the current behavior mode, and outputs it.

In the above-described example, by modeling by the HMM in the location index conversion unit 71 and the behavior state recognition unit 72, data of location and moving velocity provided by the time-series data storage unit 51 is to be converted into the data of location index and behavior mode.

However, data of location and moving velocity may be converted into the data of location index and behavior mode by another method. For example, as for the behavior mode, using a motion sensor, such as an acceleration sensor or a gyro sensor, or the like separating from the GPS sensor 11, it may be possible to detect whether the user travels, and determines the behavior mode, judging from the detection results of the acceleration, or the like.

[Destination Arrival Time Prediction Processing]

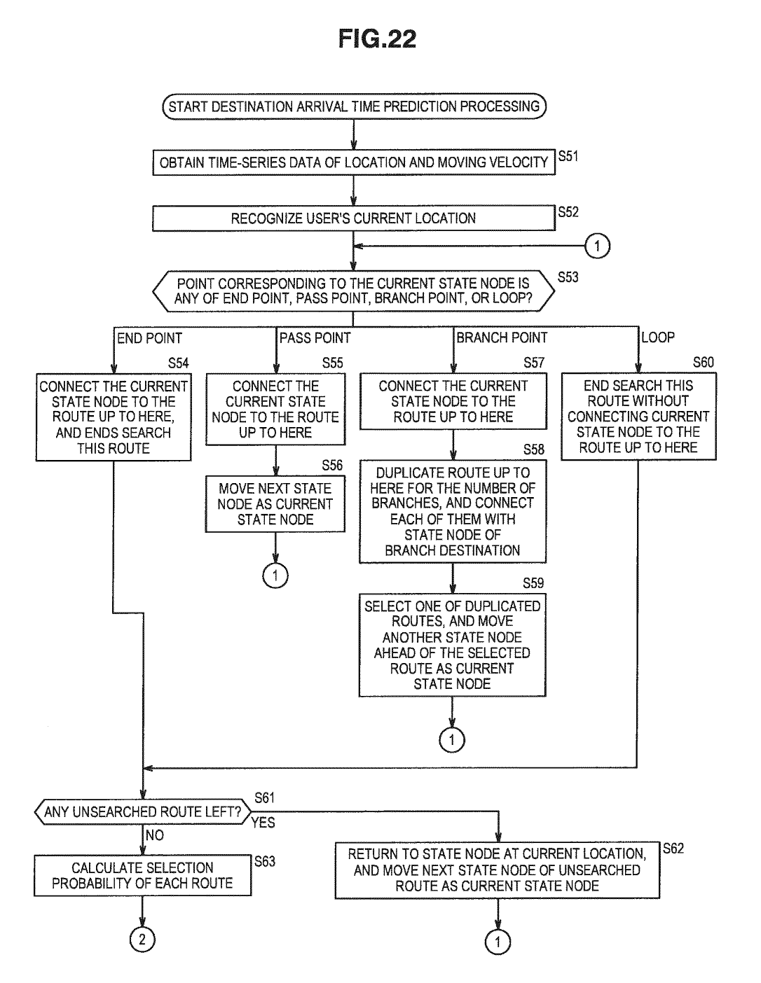

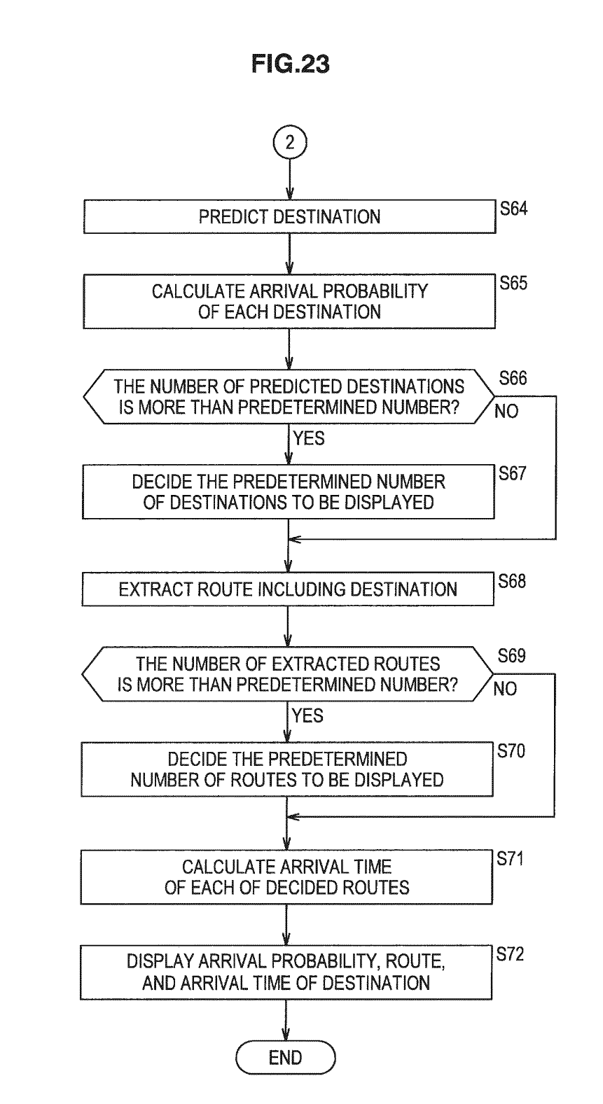

Subsequently, with reference to flow charts in FIG. 22 and FIG. 23, an explanation will be given on a destination arrival time prediction processing by the prediction system 1 in FIG. 1.

In short, FIG. 22 and FIG. 23 is flow charts of the destination arrival time prediction processing that predicts the destination from the time-series data of location and moving velocity, and calculates route and arrival time for the destination to present to the user.

Firstly in step S51, the GPS sensor 11 obtains the time-series data of location, and provides it to the behavior recognition unit 53. The behavior recognition unit 53 temporarily stores a predetermined number of samples of the time-series data of location. The time-series data obtained in step S51 is data of location and moving velocity.

In step S52, the behavior recognition unit 53 recognizes the user's current activity state from the user's activity model based on the parameters obtained through learning. That is, the behavior recognition unit 53 recognizes the user's current location. The behavior recognition unit 53 provides the behavior prediction unit 54 with the node number of the user's current state node.

In step S53, the behavior prediction unit 54 determines whether a point corresponding to the state node that is currently searched for (hereinafter, also referred to as the current state node) is either end point, pass point, branch point, or loop. After the processing of step S52, the state node corresponding to the user's current location becomes the current state node.

If the point corresponding to the current state node is determined as an end point in step S53, the processing goes to step S54, and the behavior prediction unit 54 connects the current state node with the route up to here, and ends searching this route to proceed to step S61. If the current state node is a state node corresponding to the current location, since there is no route up to here, the processing of connection is not performed. This is same as step S55, S57 and S60.

If the point corresponding to the current state node is determined as a pass point in step S53, the processing goes to step S55, and the behavior prediction unit 54 connects the current state node with the route up to here. Subsequently, in step S56, the behavior prediction unit 54 sets the subsequent state node as the current state node, and moves. After the processing of step S56, it returns to step S53.

If the point corresponding to the current state node is determined as a branch point in step S53, the processing goes to step S57, and the behavior prediction unit 54 connects the current state node with the route up to here. Subsequently, in step S58, the behavior prediction unit 54 duplicates the route up to here for the number of branches, and connects with the state node of the branch destination. Further, in step S59, the behavior prediction unit 54 selects one of the duplicated routes, sets the next state node ahead of the selected route as the current state node, and moves. After the processing of step S59, it returns to step S53.

Meanwhile, if the point corresponding to the current state node is determined as a loop in step S53, the processing goes to step S60, and the behavior prediction unit 54 ends searching this route without connecting the current state node with the route up to here, and proceeds to step S61.

In step S61, the behavior prediction unit 54 determines whether there is an unsearched route. If it is determined that there is an unsearched route in step S61, the processing goes to step S52, and the behavior prediction unit 54 returns to the current state node, sets the next state node on the unsearched route as the current state node, and moves. After the processing of step S 52, the processing returns to step S53. This executes searching unsearched routes until the search ends at a end point or a loop.

If it is determined that there is no unsearched route in step S61, the processing proceeds to step S63, and the behavior prediction unit 54 calculates the choice probability (occurrence probability) of each route that has been searched. The behavior prediction unit 54 provides the destination prediction unit 55 with each of the routes and its choice probabilities.

After processing in step S 51 to step 63 in FIG. 22 executes to recognize the user's current location, to search all of the possible routes that the user may travel, and to calculate the choice probability of each route, the processing proceeds to step S64 in FIG. 23.

In step S64, the destination prediction unit 55 predicts the user's destination. Specifically, the destination prediction unit 55 firstly lists up candidates for the destination. The destination prediction unit 55 sets a place where the user's behavior state is stay state as candidates for the destination. Subsequently, the destination prediction unit 55 determines a candidate for the destination on the route searched by the behavior prediction unit 54 as the destination among the listed candidates for the destination.

In step S65, the destination prediction unit 55 calculates arrival probability for each destination. That is, regarding a destination having a plurality of routes existing, the destination prediction unit 55 calculates sum of the choice probabilities of the plurality of routes as the arrival probability of the destination. Regarding a destination having only one route, the choice probability of the route is assumed to be the arrival probability of the destination as it is.

In step 66, the destination prediction unit 55 determines whether the number of predicted destination is more than a predetermined number of the destination. If it is determined that the number of the predated destination is more than the predetermined number of the destination, the processing proceeds to step S67, and the destination prediction unit 55 determines the predetermined number of destinations to be displayed on the display unit 18. For example, the destination prediction unit 55 can determine the predetermined number of routes in the order of higher arrival probability of the destination.

On the other hand, if it is determined that the number of predicted destination is less than the predetermined number in step S66, step S67 will be skipped. In this case, all of the predicted destinations will be displayed on the display unit 18.

In step S68, the destination prediction unit 55 extracts a route including the predicted destination from the routes searched by the behavior prediction unit 54. If a plurality of destinations has been predicted, a route is to be extracted for each of the predicted destinations.

In step S69, the destination prediction unit 55 determines whether the number of the extracted routes is more than the predetermined number as the number to be presented.

If it is determined that the number of the extracted routes are more than the predetermined number in step S69, the processing proceeds to step S70, and the destination prediction unit 55 determines the predetermined number of routes to be displayed on the display unit 18. For example, the destination prediction unit 55 can determine the predetermined number of routes in the order of higher possibility of being selected.

On the other hand, if it is determined that the number of the extracted routes are less than the predetermined number in step S69, the processing of step S70 will be skipped. In this case, all the routes to reach at the destination will be displayed on the display unit 18.

In step S71, the destination prediction unit 55 calculates the arrival time for each route decided to be displayed on the display unit 18, and provides the display unit 18 with signals of image of the arrival probability of the destination, and the route and arrival time to the destination.

In step S72, the display unit 18 displays the arrival probability of the destination and the route and arrival time to the destination based on the signals of image provided by the destination prediction unit 55, and ends the processing.

As described above, according to the prediction system 1 in FIG. 1, it is possible to predict a destination and calculate arrival probability and a route and arrival time to the destination, form moving velocity of location and moving velocity, and presents them to a user.

[Example of Processing Results by Prediction System 1 in FIG. 1]

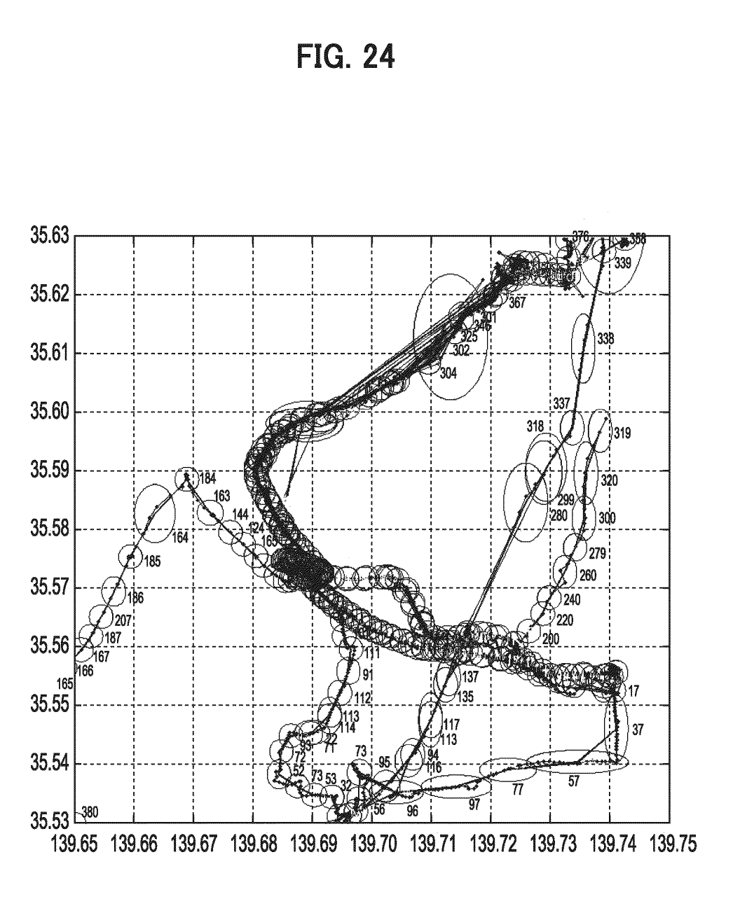

FIG. 24 to FIG. 27 show examples of results of verification experiment that verifies learning and processing of prediction of arrival time for destination by the prediction system 1 in FIG. 1. As learning data for the learning processing of the prediction system 1, data shown in FIG. 3 is used.

FIG. 24 shows results of learning parameters input in the location index conversion unit 71 in FIG. 9.

In this verification experiment, the number of state nodes is assumed 400 in the calculation. In FIG. 24, a number described close to an ellipse indicating a state node shows the node number of the state node. According to the multistream HMM the at has been learned shown in FIG. 24, state nodes are learned so as to cover the user's travel routes. That is, it is understood that the user's travel routes have been accurately learned. The node number of this state node is to be input to the integrated learning unit 62 as a location index.

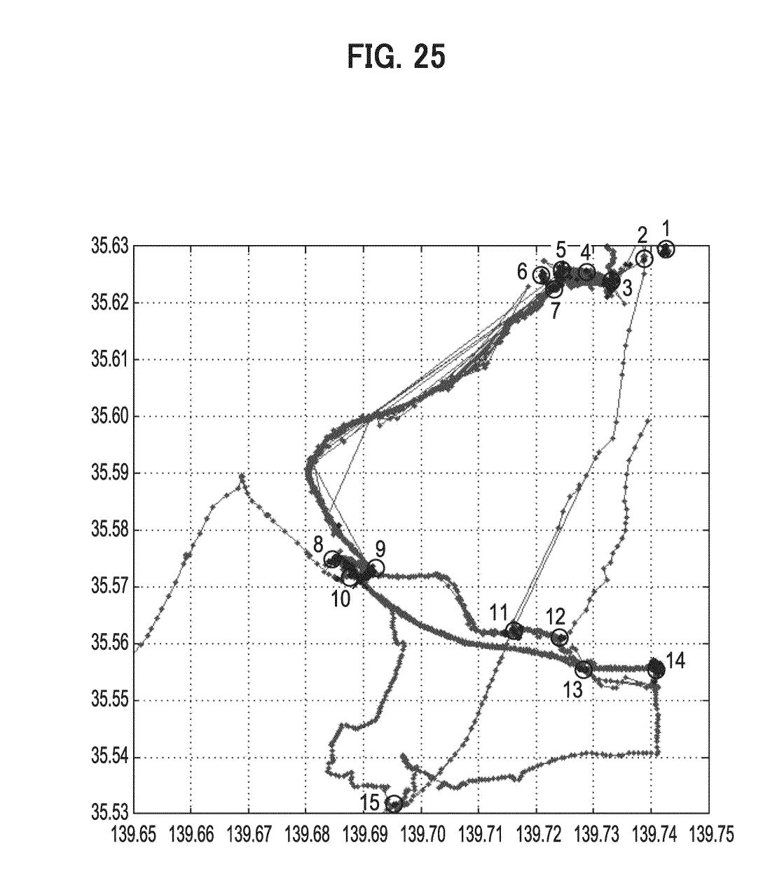

FIG. 25 shows results of learning parameters input in the behavior state recognition unit 72 in FIG. 9.

In FIG. 25, a point (location) recognized that the behavior mode is “stay” is plotted in black. And a point recognized that the behavior mode is other than “stay” (such as, “walk” or “train (local)) is plotted in gray.

Moreover, in FIG. 25, location listed up as a staying location by the experimenter who actually made the learning data is circled with a white circle. A number described close to the circle is an ordinal number simply attached for differentiating each staying location.

According to FIG. 25, a location indicating the stay state that has been decided through learning corresponds to a location that the experimenter listed up as the staying location, and it is understood that the user's behavior state (behavior mode) has been accurately learned.

FIG. 25 shows the learning results of the integrated learning unit 62.

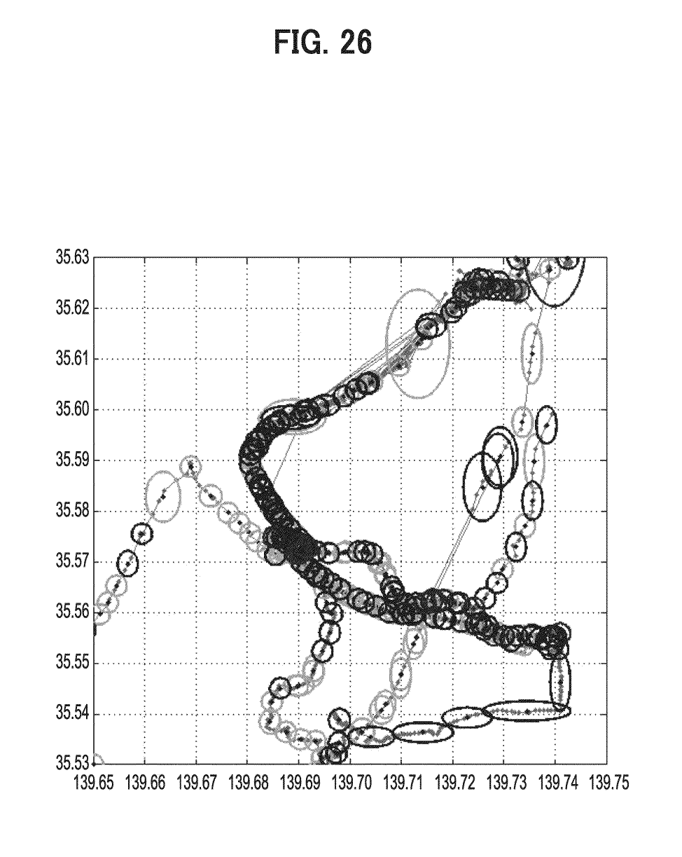

In FIG. 26, due to the restrictions of the figure, it is not presented on the figure, however, among each state node of the multistream HMM which were obtained through learning, state nodes whose observation probability of “stay” is equal or more than 50 percent corresponds with the location indicated in FIG. 25.

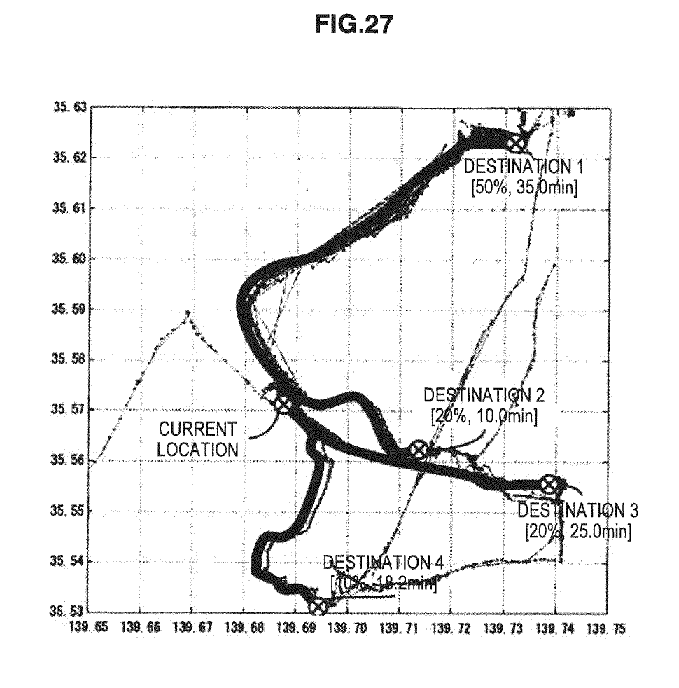

FIG. 27 shows results of the destination arrival time prediction processing in FIG. 22 and FIG. 23 by the learning model (the multistream HMM) that the integrated learning unit 62 learns.

According to the result shown in FIG. 27, regarding the current location, the visiting places 1 to 4 shown in FIG. 3 is respectively predicted as the destinations 1 to 4, and arrival probability and arrival time to each of the destination are calculated.

The arrival probability of the destination 1 is 50 percent, and the arrival time is 35 minutes. The arrival probability of the destination 2 is 20 percent, and the arrival time is 10 minutes. The arrival probability of the destination 3 is 20 percent, and the arrival time is 25 minutes. The arrival probability of the destination 4 is 10 percent, and the arrival time is 18.2 minutes. Moreover, each route to the destinations 1 to 4 is represented in thick solid lines respectively.

Therefore, according to the prediction system 1 of FIG. 1, it is possible to predict destination from a user's current location, and further predict route for the predicted destination and its arrival time to present to the user.

Note that in the above-described example, the destination is to be predicted from the user's behavior state, however, the prediction of destination is not limited to this. For example, the destination may be predicted by a place which the user inputted as a destination in the past.

The prediction system 1 in FIG. 1 displays information on destination with the highest arrival probability according to such prediction results on the display unit 18. For example, when the destination is a station, or the like, a time table of the station can be displayed, or when the destination is a shop, detailed information of the shop (business hours, sale information, or the like) can be displayed. This enhances user's convenience further.

Further, according to the prediction system 1 in FIG. 1, it is possible to predict behavior with conditions by inputting other conditions that influences user's behavior in time-series as the time-series data. For example, by learning after inputting the day of the week (weekdays and holidays), predictions of destination or the like can be done in a case where behaviors (or destination) differ depending on a day of the week. Further, by learning after inputting conditions such as time zone (or, morning/afternoon/evening), predictions of destination can be done in a case where behaviors differ depending on a time zone. Further, by learning after inputting conditions such as weather (fine/cloudy/rainy) or the like, predictions of destination can be done in a case where behaviors differ depending on weather conditions.

In the above-described embodiment, the behavior state recognition unit 72 is mounted as a conversion means for converting moving velocity into behavior mode in order to input the behavior mode into the integrated learning unit 62 or 62′. However, it is also possible to use the behavior state recognition unit 72 solely by itself as a behavior state identification apparatus for identifying whether a user is in the travel state or in the stay state with respect to the input moving velocity, or if in the travel state, further identifying which travel means is used for traveling, or the like, and for outputting them. In this case, the output of the behavior state recognition unit 72 can also be input into different applications.

<2. Information Presenting System>

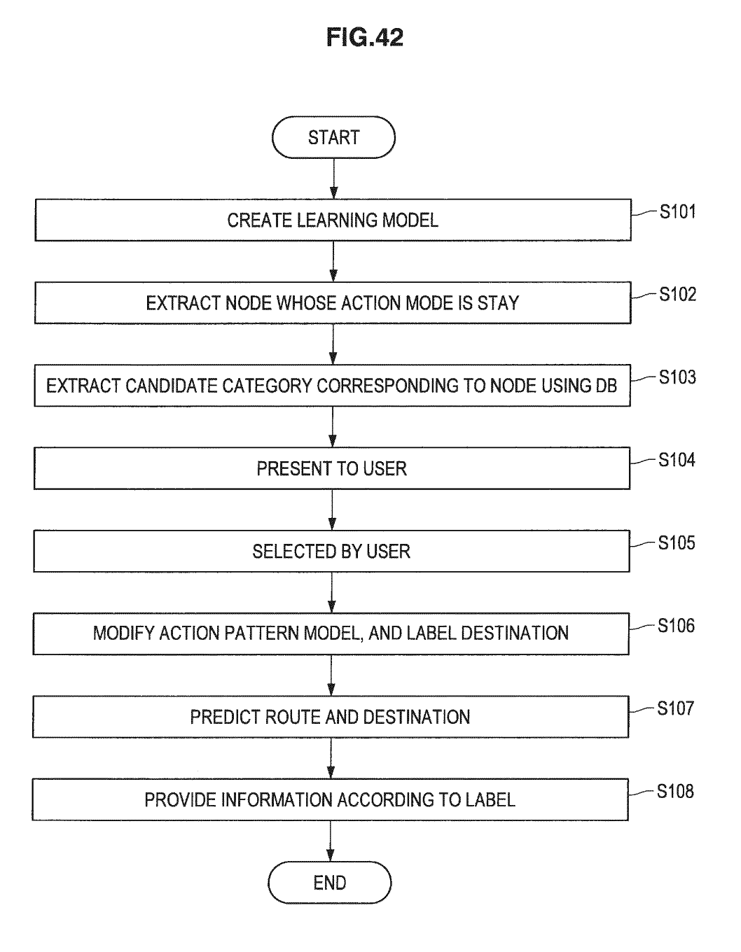

FIG. 42 is a flow chart showing processing of an information presenting system according to the present embodiment.

As described above, as the GPS data is input into a learning algorithm, a learning model is created (step S101). In other words, as explained using FIG. 9, the behavior learning unit 52 learns both the user's travel route and behavior state at the same time using the time-series data of location of longitude/latitude or the like and the time-series data of moving velocity stored in the time-series data storage unit 51 (FIG. 1).

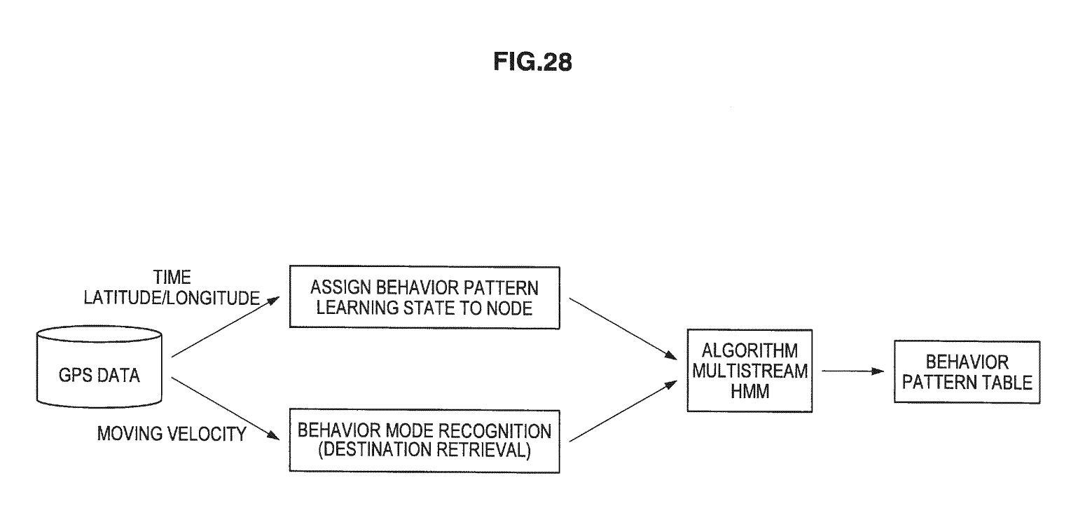

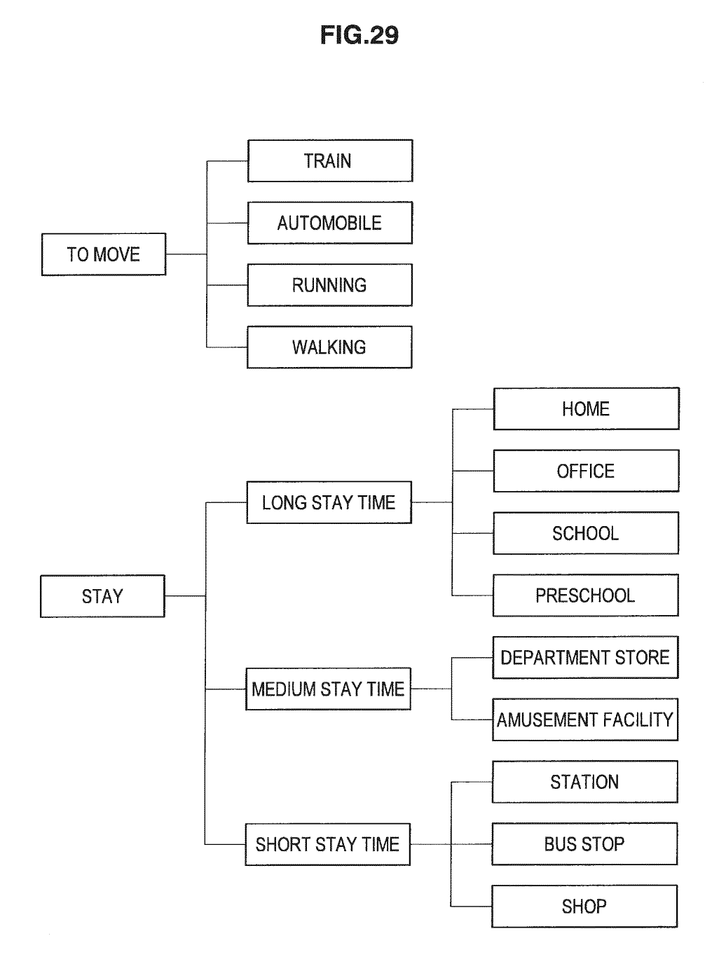

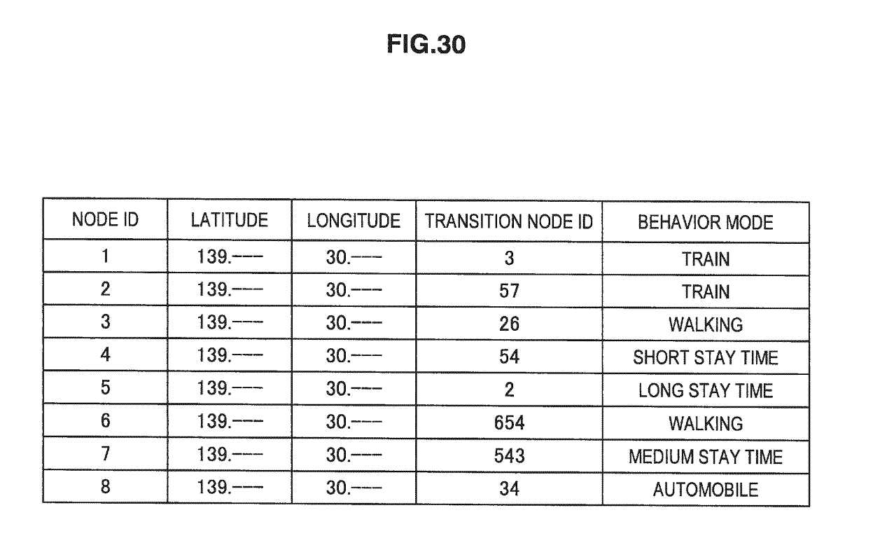

In the learning model, user's travel route is divided into a certain number of state nodes. As the result, according to the flow shown in FIG. 28, a behavior pattern table as illustrated in FIG. 30 is created. Each state node is corresponds to the location information, and has a transition node and a behavior mode respectively. The transition node is a state node having a high probability to transition among the state nodes successive to the current state node. In FIG. 30, as the transition node, one node ID is described, however, a plurality of transition nodes may exist for each state node. The behavior node is classified into a plurality of states as shown in FIG. 12 or FIG. 29. As illustrated in FIG. 30, each state node is labeled with any of behavior modes such as train, automobile, or the like if it is travel, or long stay time, medium stay time, or short stay time if it is stay.

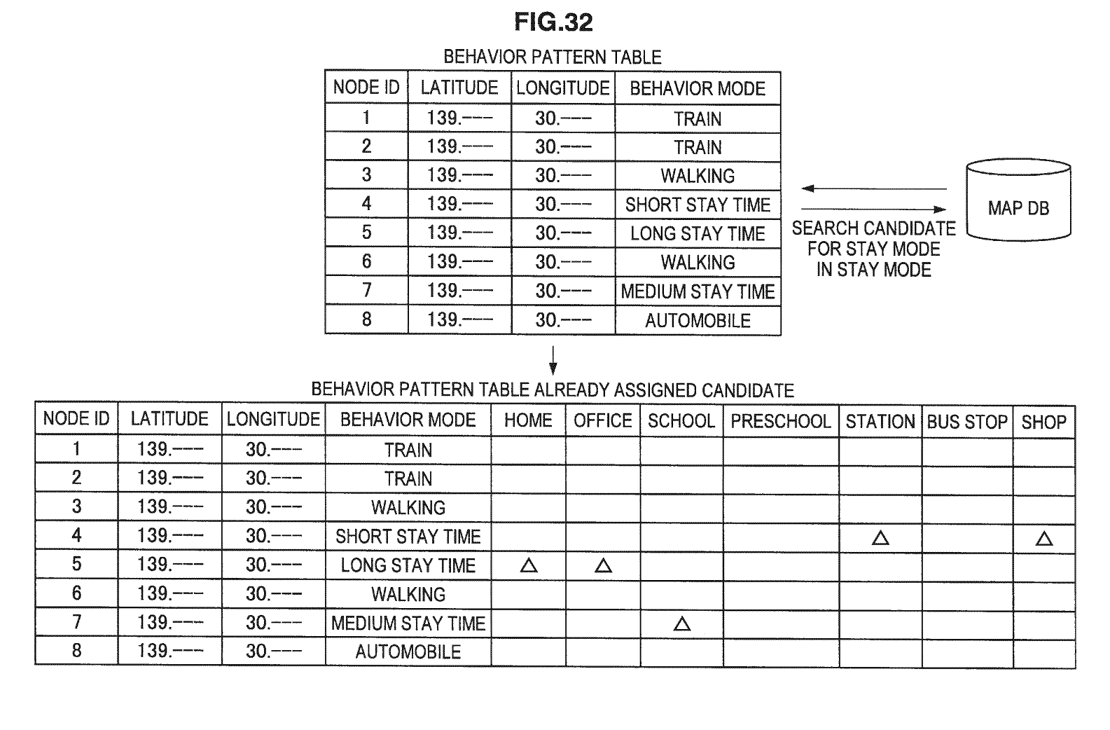

Subsequently, among the plurality of state nodes described in the behavior pattern table, nodes whose behavior mode is stay are extracted (step S102). As illustrated in FIG. 32, using the map DB, candidate categories corresponding to the state node in stay are extracted (step S103). This enables detailed candidates to be decided regarding the state nodes whose behavior mode is stay.

At first, regarding the state node whose behavior mode is stay in the behavior pattern table, the map DB is searched based on latitude/longitude of the state node. The map DB (database) is a map, and a map added with attribute information on various locations. By searching the map DB, among a plurality of categories, such as home, office, preschool, station, bus stop, shop, or the like, one or a plurality of candidate categories are to be extracted based on the latitude/longitude. A candidate category is a candidate for a category that indicates where the state node stays. Category is location attributed information in a size from as large as prefecture or state, to as large as home, office, station shop, railroad, street. Note that category is not limited to places, but may be time attributed information. The user's behavior time is recognized based on the behavior mode, and candidate for usage time zone can be presented to the user. As the result, as shown in FIG. 32, candidate category is assigned to each state node whose behavior mode is stay. FIG. 32 is a behavior pattern table that is assigned with candidate category. As for the category candidate, it is possible to check one of the category candidates, or a plurality of the category candidate.

It is also possible to narrow the category to be searched depending upon the level of staying time, when searching categories. For example, if staying time is long, it can narrow the search down to home category and office category. If staying time is short, it can narrow the search down to stations and shops.

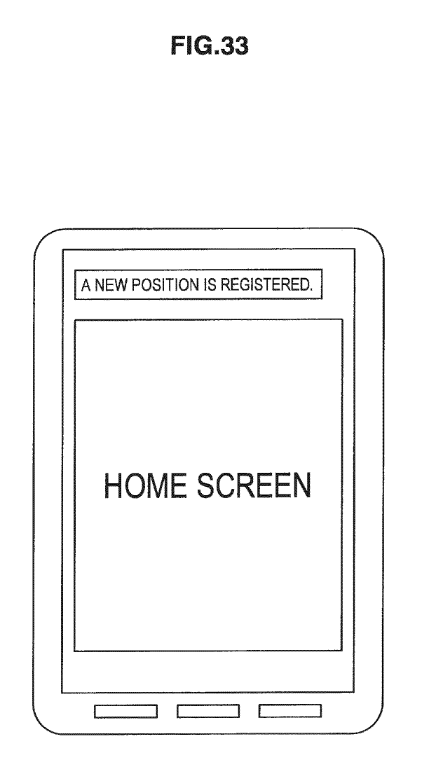

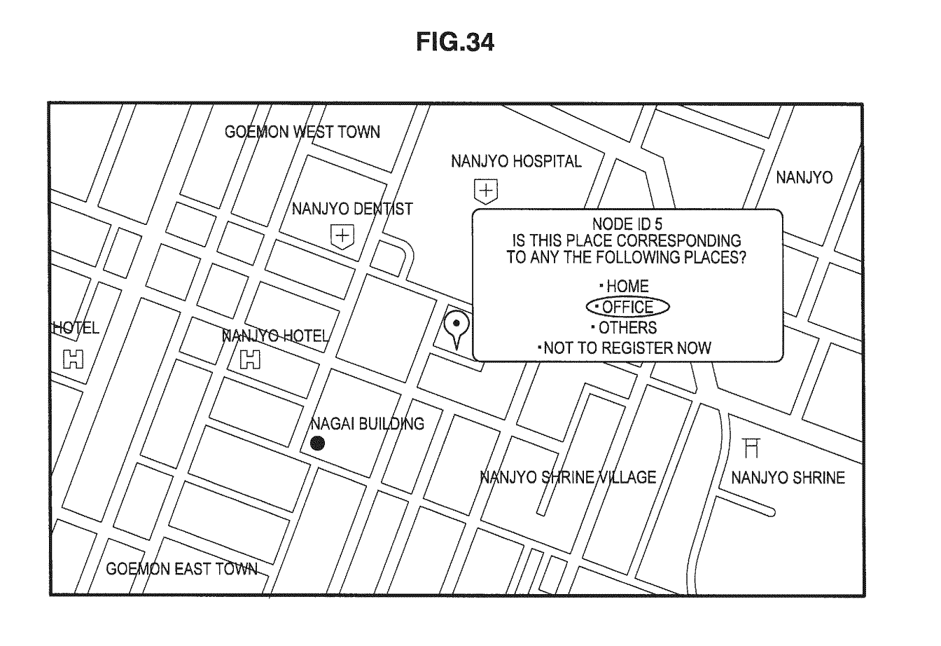

When candidate category is extracted for the state node, the candidate category is presented to the user (step S104). On a screen of a terminal like the one shown in FIG. 33, there are items necessary for location registration displayed on the screen, and a message is displayed to encourage the registration. This display of the message is executed at an arbitrary timing to the user. The way of presenting may use a sound equipment or vibrator, or the like, other than the display apparatus at terminal.

FIG. 34 shows display example of a screen at the time of location registration. A map is displayed in the screen, and the map is marked on a region corresponding to the latitude/longitude of the state node assigned with the candidate category so as to be clear its position. One or more than one candidate categories are presented on the screen.

According to the contents presented, one or more than one categories among the candidate categories are to be selected by the user (step S105). Selection of the categories may be on hold.

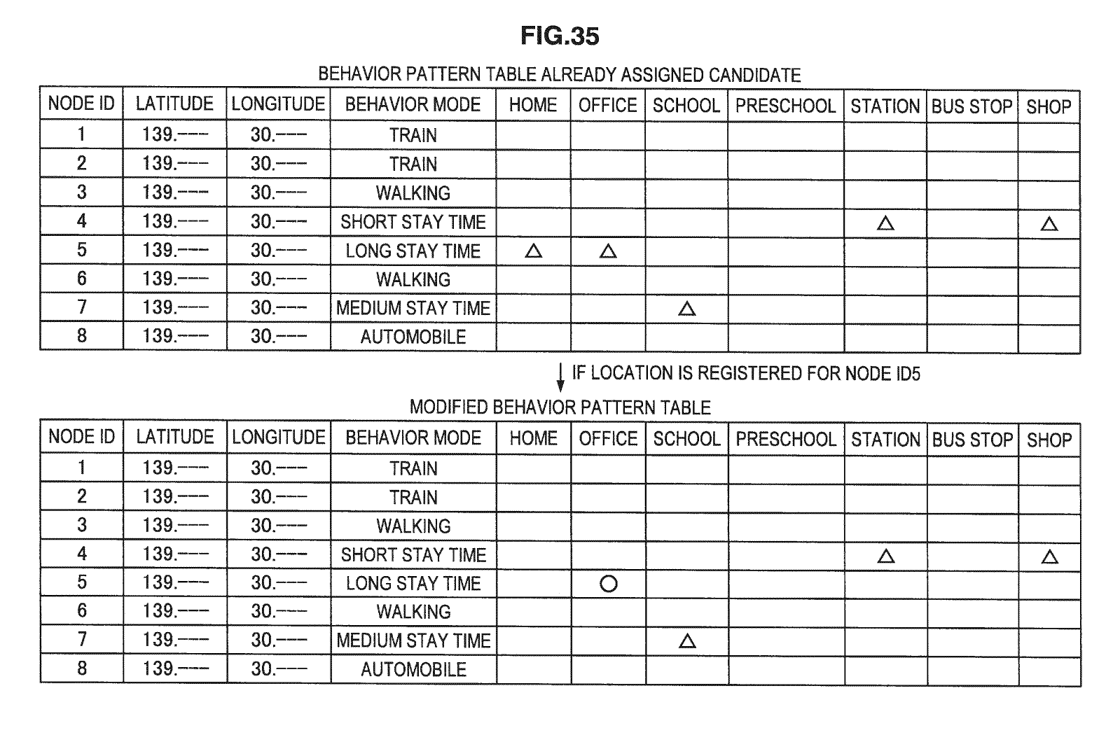

User's selection determines categories indicating where the state nodes stay. As the result, as shown in FIG. 35, the behavior pattern table is modified (step S106). In addition, the determined category is labeled to the state node as a destination details label. In the example of FIG. 35, a location registration is executed for the state node whose node ID is 5, and whose behavior mode is stay, and the state node whose node ID is 5 is represented to stay at office.

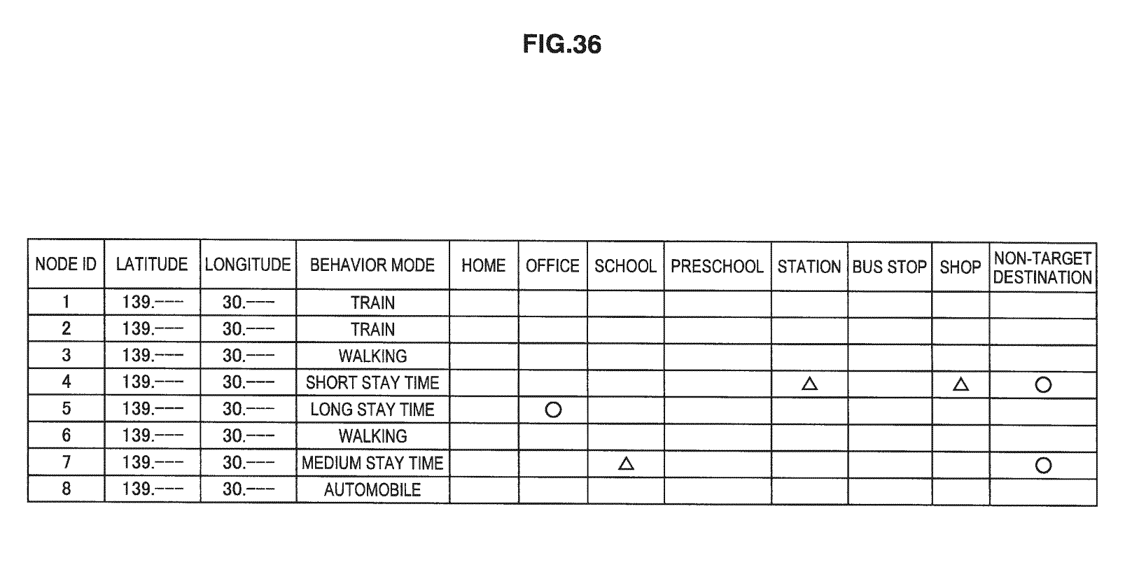

Moreover, if the location corresponding to the state node is a non-target destination, being a non-target destination is checked (step S106). The way to make it as a non-target destination is that the user confirms location on a terminal screen, and manually sets the location to be a non-target. When the state node is determined to be a non-target destination, the behavior pattern table is modified as shown in FIG. 36. In the example of FIG. 36, node ID 4, and 7 are non-target destinations. The categories of the state nodes which turn out to be non-target destinations may leave unchecked as illustrated in the node ID 4 in'FIG. 36, or the check itself may be deleted.

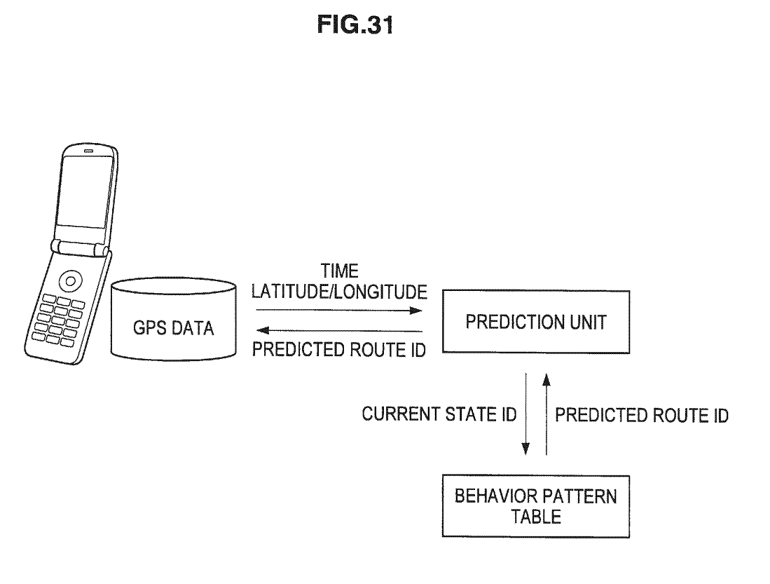

Next, after location has been registered for the state node, routes and destinations are predicted (step S107). In the past, using the behavior pattern table without a location registration shown in FIG. 30, routes and destinations were predicted as illustrated in FIG. 31. A prediction unit converted current time or latitude/longitude information obtained by a client terminal into a current state ID by state recognition algorithm, and returned predicted route ID to the client terminal using the current state ID and the behavior pattern table.

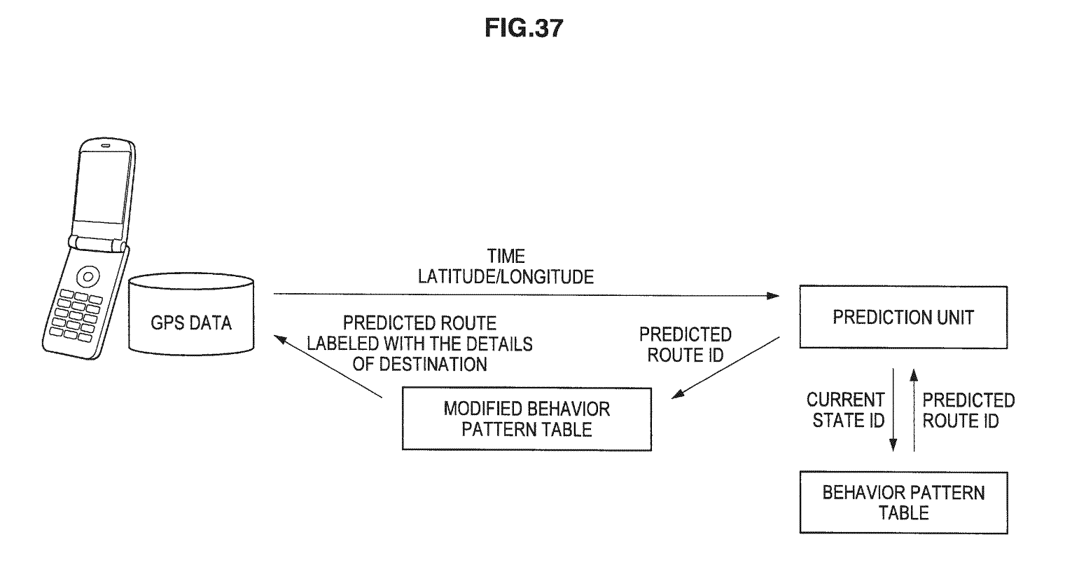

On the other hand, according to the present embodiment, as illustrated in FIG. 37, by inputting time and latitude/longitude based on the current GPS data, and by using the existing behavior pattern table, the prediction unit outputs the node ID of the predicted route. Prediction of routes enables the node ID corresponding to the destination to be determined. Further, by matching the node ID of the predicted route and the modified behavior pattern table, it is determined whether there is the one with label among the node IDs targeted as the destination of the predicated route. If the destination is labeled, the user will be notified of information according to the label (step S108).

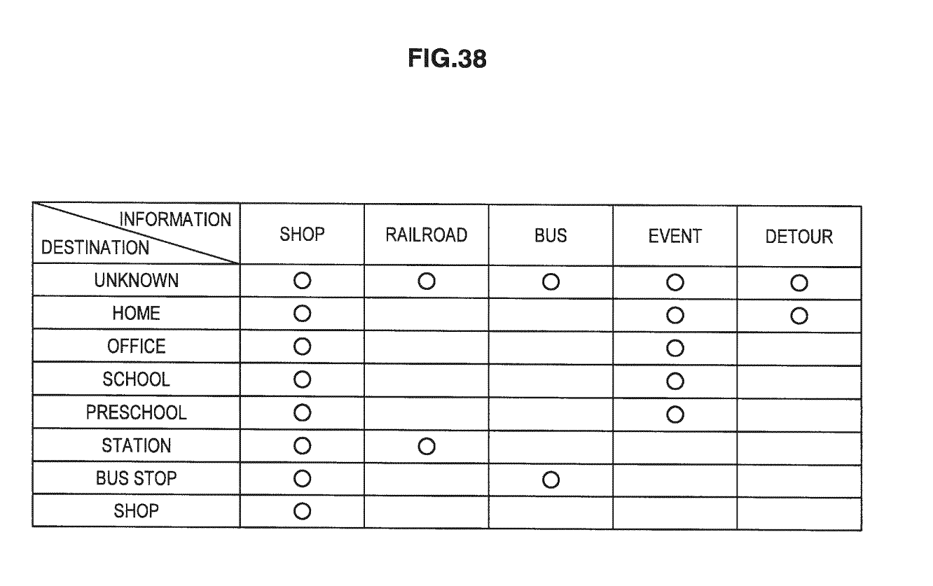

FIG. 38 shows destinations and kinds of presented information of the modified behavior pattern table. If the destination is labeled, information appropriate for the destination only is to be provided. For example, if the destination is home, information on shops, events, places to detour in the neighborhood of home are presented. If the label of the destination is unknown, all the information possible to be presented is presented. In other words, information presented to the user is determined to be different depending upon the attributes of the destination.

For example, if a destination of a predicted route is labeled as “station”, route information from the station is to be provided. Information may be provided not when a route from the current location is predicted. For example, that is the time when a time zone is registered for the state node. For example, when a traffic label, such as a “station” label, is added, usage time zone may be also registered as an option. When a train delay, or the like, is occurred during the usage time zone at the station, information is provided with or without a prediction. Further, if there is a case where destination of the route is labeled as “shop” and the time zone is labeled as “from 19 o'clock to 22 o'clock”, information consisted of dinner menu of the shop would be provided.

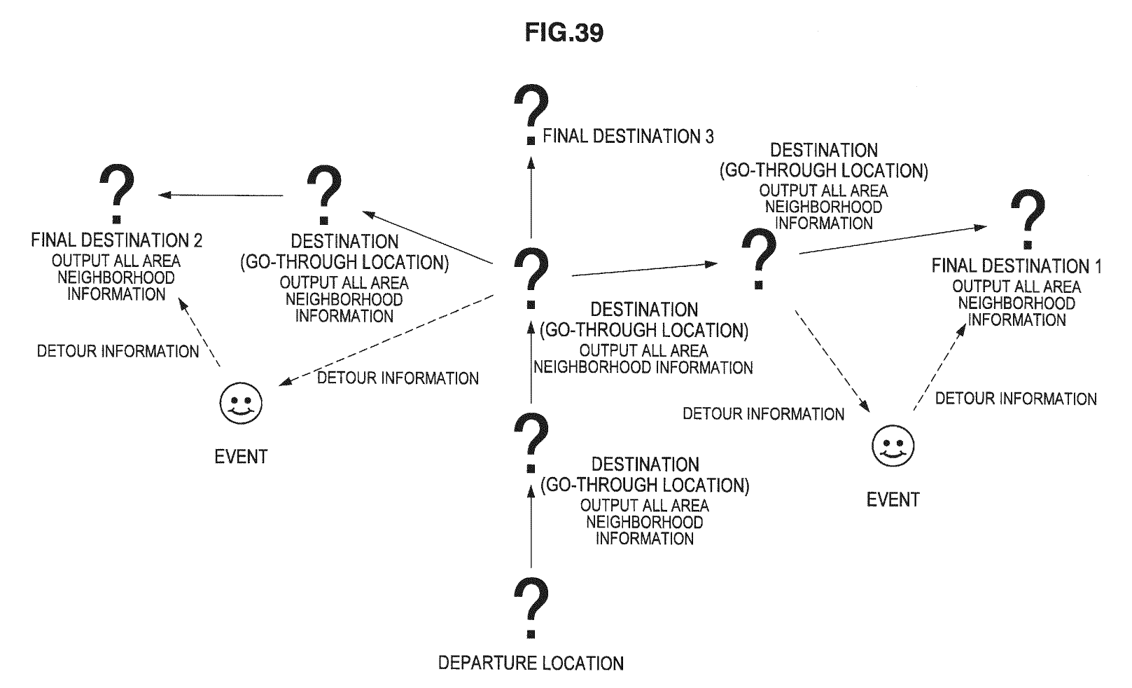

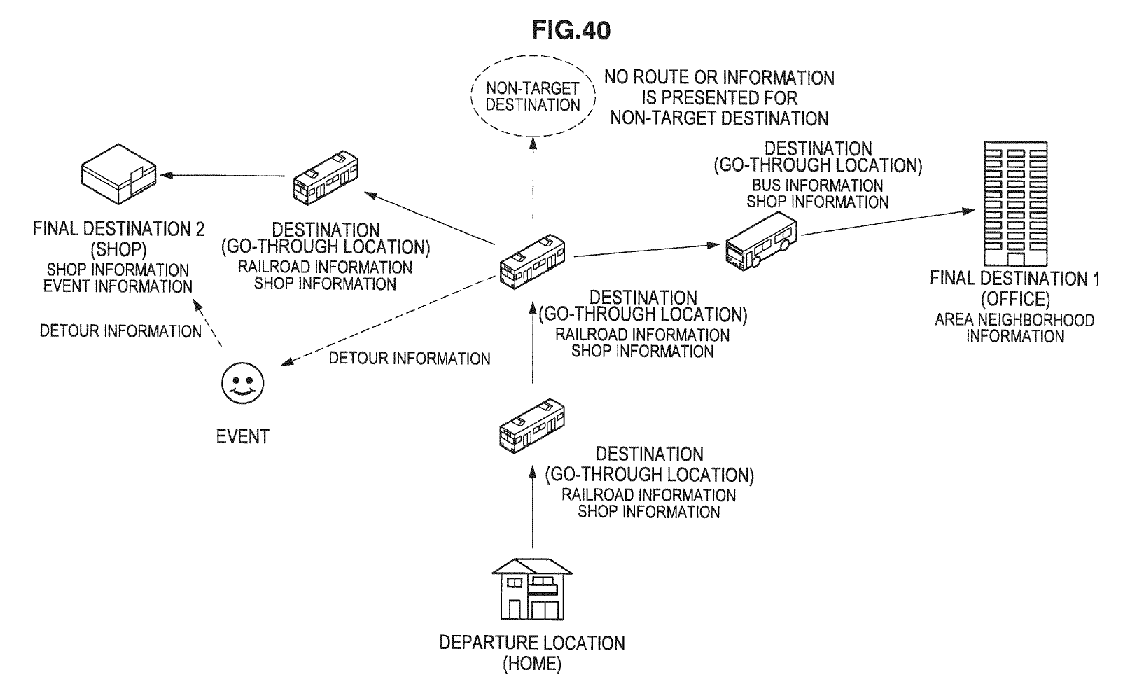

FIG. 39 and FIG. 40 show an example of prediction using the behavior pattern table and the modified behavior pattern table respectively.

In the prediction example using the behavior pattern table in the past, it is not decided what the destination on the predicted route is like. For that reason, all of the corresponding neighborhood information was provided to the user. This causes a probability that truly necessary information for the user would be buried. For example, if there are a station and a bus stop in the neighborhood of the unknown destination, time information of the station and the bus stop would be provided. However, if there is the one the user actually uses at the station, the bus stop information is useless for the user.

Further, depending on a route, there may be information discomfort for the user if it is provided. For example, if the final destination 1 in FIG. 39 is an office, presenting the detour information on commuting hours may result in discomfort for the user. On the other hand, in the example of the prediction using the modified behavior pattern table in FIG. 40, all the destination on the predicted routes are determined by the user's feedback. Therefore, contents of the presented information can be selected by a program in advance. For example, since a go-through point is decided by the user's selection, route information at an appropriate time can be presented. Further, if it is decided to use a bus from the go-through point, route information of an appropriate time can be presented. Further, depending upon kinds of final destination, presenting information discomfort for the user can be controlled. For example, if the final destination is an office, it can be controlled not to provide detour information. Further, it can be controlled not to present either route or information to the non-target destination.

Information presenting to the user include not only railway information, railroad traffic information, road traffic information, typhoon information, earthquake information, event information, or the like, but also a reminder of presenting information that the user has registered in association with location to be presented to the user who comes close to the location, upload and download of data, or the like.

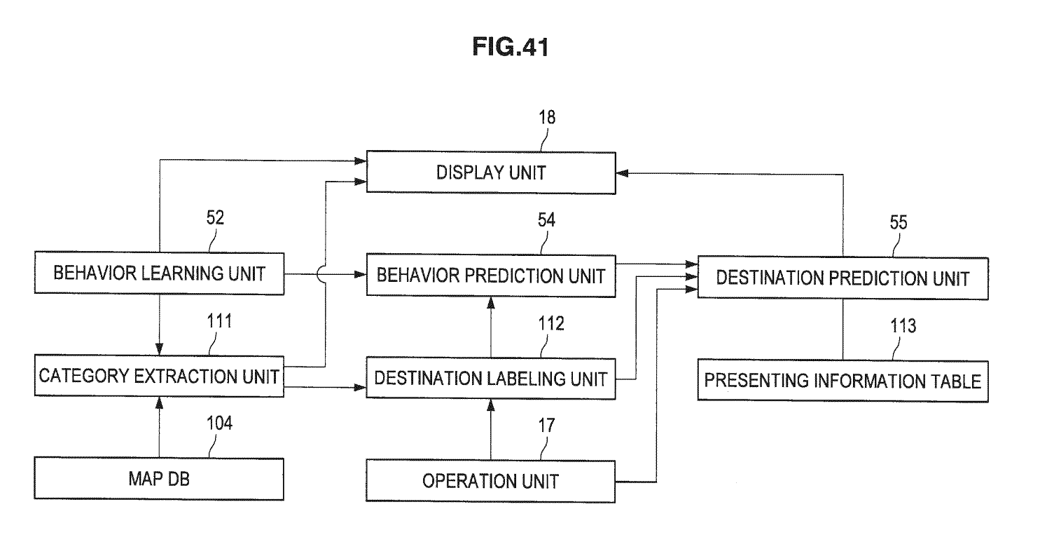

In conclusion, the prediction system 1 of the present embodiment includes not only the constituent elements illustrated in FIG. 1, but also the constituent elements illustrated in FIG. 41. The prediction system 1 further includes a category extraction unit 111, a destination labeling unit 112, a presenting information table 113, and a map DB 104. The category extraction unit 111, the destination labeling unit 112, the presenting information table 113, and the map DB 104 may be mounted on the mobile terminal 21 or may be mounted on the server 22 illustrated in FIG. 2.

The category extraction unit 111 refers to location information or behavior mode of the state node and the map DB 104, and extracts category candidates. The destination labeling unit 112 assigns a category candidate to a state node, or registers at least one category candidate as a label among category candidates selected by the user. The presenting information table 113 is a table associated with information to be presented with the category, and manages so as to present appropriate information depending upon categories. The map DB 104 includes map data and attribute information of location associated with the map data.

The series of processing described above may be executed by hardware or software. When executing the series of processing by software, programs configured of the software is installed into a computer. Here, as a computer, a computer built-in dedicated hardware and a computer capable of executing various functions by installing various programs, such as, a general-purpose personal computer are included.

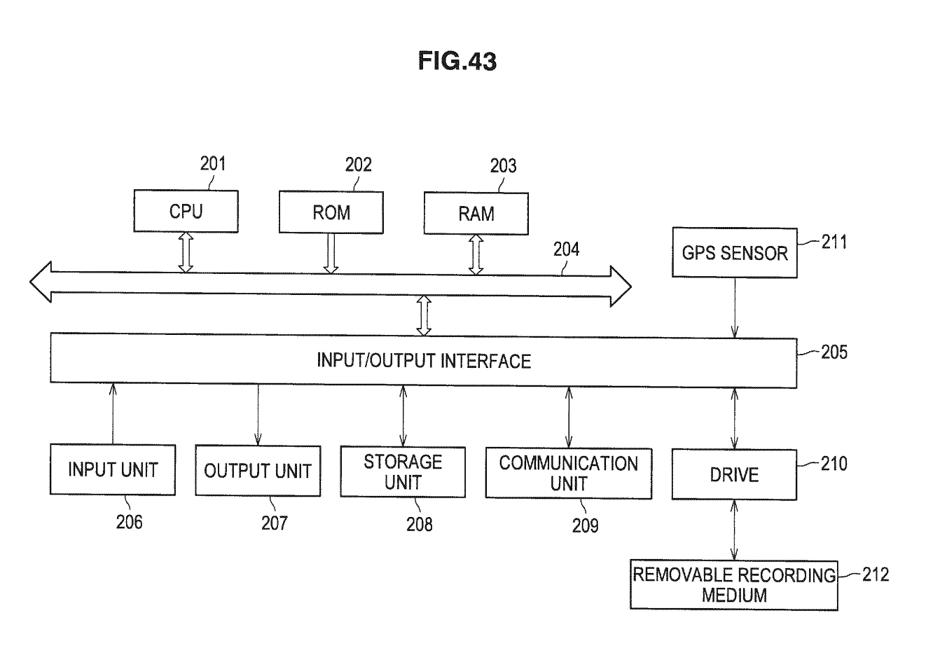

FIG. 43 is a block diagram showing a configuration example of computer hardware for executing the above-described series of processing by programs.

In the computer, a CPU (Central Processing Unit) 201, a ROM (Read Only Memory) 202, and a RAM (Random Access Memory) 203 are mutually connected to a Bus 204.

The bus 204 is further connected to an input/output interface 205. The input/output interface 205 is connected to an input unit 206, an output unit 207, a storage unit 208, a communication unit 209, a drive 210, and a GPS sensor 211.

The input unit 206 is configured from a keyboard, a mouse, a microphone, or the like. The output unit 207 is configured from a display, a speaker, or the like. The storage unit 208 is configured from hardware, a nonvolatile memory, or the like. The communication unit 209 is configured from network interface, or the like. The drive 210 drives a removable recording medium 212, such as a magnetic disk, an optical disk, a magneto-optical disk, or a semiconductor memory, or the like. The GPS sensor 211 corresponds to the GPS sensor 11 in FIG. 1.

The CPU 201 loads programs stored in the storage unit 208 into the RAM 203 through the input/output interface 205 and the bus 204, and executes the programs to perform the above series of processing, in the computer configured as above.

Programs that the computer (CPU201) executes can be recorded on the removable recording medium 212 as a media package, or the like, and can be provided. The programs can be provided through wired or wireless transmission medium, such as local area network, internet, digital satellite broadcasting, or the like.

Programs can be installed into the storage unit 208 through the input/output by mounting the removable recording medium 212 to the drive 210 in the computer. Further, programs can be received by the communication unit 209 through wired or wireless transmission medium to be installed in the storage unit 208. In addition, programs can be installed in the ROM 202 or the storage unit 208 in advance.

Note that programs that the computer executes may be programs that execute processing in time-series following the order explained in this specification, or may be programs that execute processing at timing as necessary, such as in parallel, or in response to a call.

Note that in this specification, steps described in flow charts may be executed not only in time-series following the order described, or if not executed in time-series, may be executed at timing as necessary in parallel, or in response to a call.

In this specification, a system represents an overall apparatus configured from a plurality of devices.

It should be understood by those skilled in the art that various modifications, combinations, sub-combinations and alterations may occur depending on design requirements and other factors insofar as they are within the scope of the appended claims or the equivalents thereof.

For example, in the above embodiment, it has been explained a case that when the behavior mode is stay, candidates for category of location is to be presented to the user, however, the present disclosure is not limited to this example. For example, candidates for usage time zone of location may be represented to the user by recognizing the user's behavior time from the behavior mode.

The present disclosure contains subject matter related to that disclosed in Japanese Priority Patent Application JP 2010-137555 filed in the Japan Patent Office on Jun. 16, 2010, the entire content of which is hereby incorporated by reference.

What is claimed is:

1. An information processing apparatus, comprising:
a behavior learning unit that learns an activity model representing an activity state of a user as a probabilistic state transition model from time-series data of the user's location, and that finds a state node corresponding to a location where the user conducts activities using the user's activity model;
a candidate assigning unit that assigns category candidates related to location or time to the state node; and
a display unit that presents the category candidate to the user.

2. The information processing apparatus according to claim 1, further comprising:
a map database including map data and attribute information of a location associated with the map data; and
a category extraction unit that extracts the category candidates based on the state node and the map database.

3. The information processing apparatus according to claim 1, further comprising:
a behavior prediction unit that predicts routes available from the state node;
a labeling unit that registers at least one of the category candidates among the category candidates as a label to the state node; and
an information presenting unit that provides information related to the state node included in the predicted routes based on the registered label.

4. The information processing apparatus according to claim 3, wherein
the information related to the state node is determined in accordance with an attribute of the label.

5. An information processing method comprising:
learning an activity model representing an activity state of a user as a probabilistic state transition model from time-series data of the user's location, and finding a state node corresponding to a location where the user takes actions using the user's activity model;
assigning category candidates related to location or time to the state node; and
presenting the category candidate to the user.

6. A program for causing a computer to execute:
learning an activity model representing an activity state of a user as a probabilistic state transition model from time-series data of the user's location, and that finds a state node corresponding to a location where the user takes actions using the user's activity model;
assigning category candidates related to location or time to the state node; and
presenting the category candidate to the user.
